(19) United States
(12) Patent Application Publication
(10) Pub. No.: US 2014/0362120 A1
(43) Pub. Date: Dec. 11, 2014

(54) METHOD AND APPARATUS FOR DISPLAYING ANALYTICS VIA CONFIGURABLE VISUALIZATIONS

(71) Applicant: ZIH Corp., Lincolnshire, IL (US)

(72) Inventors: Michael A. Wohl, Talbott, TN (US); James J. O'Hagan, McHenry, IL (US); Anthony R. Brown, Spring Grove, IL (US); Wolfgang Strobel, Tolland, CT (US); Dean Lodwig, West Hills, CA (US)

(21) Appl. No.: 14/297,229

(22) Filed: Jun. 5, 2014

Related U.S. Application Data
(63) Continuation-in-part of application No. 13/942,316, filed on Jul. 15, 2013.
Application No. 13/942,316 is a continuation-in-part of application No. 13/942,139, filed on Jul. 15, 2013.
(60) Provisional application No. 61/831,990, filed on Jun. 6, 2013.
(60) Provisional application No. 61/831,990, filed on Jun. 6, 2013.
(60) Provisional application No. 61/831,990, filed on Jun. 6, 2013.

(51) Int. Cl. G06T 3/40

(52) U.S. Cl. CPC G06T 3/40; G06T 2207/30228
USPC 345/661

(57) ABSTRACT

A method, apparatus, computer program product, and system provide for displaying analytics data based upon aggregated data corresponding to an object via an interface. The method may include receiving analytic data corresponding to at least one object characteristic. The method may also include generating at least one display element having the analytic data corresponding to the at least one object characteristic at one or more time intervals, and causing the at least one display element to be displayed in an interface. The interface may be configured to size the at least one data element within the user interface to enable the display of a plurality of display elements in the display. The interface may be further configured to receive an input corresponding to a user input.

### CROSS-REFERENCE TO RELATED APPLICATION

This application claims priority from and the benefit of the filing date of U.S. Provisional Patent Application No. 61/831,990 filed Jun. 6, 2013 the contents of which is incorporated by reference in its entirety herein.

This application is a continuation in part of U.S. patent application Ser. No. 13/942,316, filed Jul. 15, 2013 which claims the priority from and the benefit of the filing date of U.S. Provisional Patent Application No. 61/831,990 filed Jun. 6, 2013 the contents of which is incorporated by reference in its entirety herein.

This application is also a continuation in part of U.S. patent application Ser. No. 13/942,139, filed Jul. 15, 2013, which claims the priority from and the benefit of the filing date of U.S. Provisional Patent Application No. 61/831,990 filed Jun. 6, 2013 the contents of which is incorporated by reference in its entirety herein.

### TECHNOLOGICAL FIELD

An example embodiment of the present invention generally relates to displaying analytics and more particularly, to a system configured to display analytic data to users via an interface.

### BACKGROUND

Location based services allow for a user to identify the location of a particular participant, object, tag, and/or object. In addition, various analytics may be determined based upon location data of an object, such as an athlete's location during a game. When the object data, such as object location data, is aggregated, various analytics may be determined. For example, accurate analytics related to sports and athlete performance has been highly desired and may be determined based upon data corresponding to the location of the athlete. In another example, accurate analytics related to livestock has been highly desired and may be determined based upon data corresponding to the location of the livestock. Displaying analytics in an efficient and concise manner has been difficult to accomplish in an efficient and concise manner. Through applied effort, ingenuity and innovation, Applicant has solved many of these identified problems by developing a solution that is embodied by the present invention, which is described in detail below.

### BRIEF SUMMARY

A method, apparatus, computer program product, and system therefore provide for displaying analytics data based upon aggregated data corresponding to an object via an interface. In some embodiments, the method comprises receiving analytic data corresponding to at least one object characteristic, generating at least one display element having the analytic data corresponding to the at least one object characteristic at one or more time intervals, and causing the at least one display element to be displayed in an interface, wherein the interface is configured to size the at least one data element within the user interface to enable the display of a plurality of display elements in the display, the interface being further configured to receive an input corresponding to a user input. The method may further comprise causing, via a processor, based at least in part on the input, the performance of an operation associated with the display element that has been selected.

In some embodiments, the analytic data includes analytic data determined from object data corresponding to a tag location. The tag may be configured to communicate using ultra-wide band signals. According to some embodiments, the interface is configured to display at least one display element configured to display analytic data in varying levels of detail. The interface may be configured to display the at least one display element configured to display analytic data in at least one of an icon form, a graph form, a panel form, and a full function display element form. In some embodiments, the full function display element form is displayed as a larger display element than the icon form, the graph form, and the panel form. The panel form may be displayed as a larger display element than the graph form and the icon form. Further, the graph form may be displayed as a larger display element than the icon form. In some embodiments, the interface may be further configured receive an input corresponding to a user input requesting at least one display element to be change from any one of the display forms to another display form.

Some embodiments of the present invention provide an apparatus comprising at least one processor and at least one memory including computer program code, the at least one memory and the computer program code configured to, with the processor, cause the apparatus to receive analytic data corresponding to at least one object characteristic, generate at least one display element having the analytic data corresponding to the at least one object characteristic at one or more time intervals, and cause the at least one display element to be displayed in an interface, wherein the interface is configured to size the at least one data element within the user interface to enable the display of a plurality of display elements in the display, the interface being further configured to receive an input corresponding to a user input.

The apparatus may be further configured to perform an operation associated with the display element that has been selected. In some embodiments, the analytic data includes analytic data determined from object data corresponding to a tag location. The tag may be configured to communicate using ultra-wide band signals. In some embodiments, the interface is configured to display at least one display element configured to display analytic data in varying levels of detail. The interface is configured to display the at least one display element configured to display analytic data in at least one of an icon form, a graph form, a panel form, and a full function display element form. The full function display element form is displayed as a larger display element than the icon form, the graph form, and the panel form. The panel form is displayed as a larger display element than the graph form and the icon form. The graph form is displayed as a larger display element than the icon form. In some embodiments, the interface is further configured receive an input corresponding to a user input requesting at least one display element to be change from any one of the display forms to another display form.

According to some embodiments, a computer program product comprises at least one computer readable non-transitory memory medium having program code instructions stored thereon, the program code instructions which when executed by an apparatus cause the apparatus at least to receive analytic data corresponding to at least one object characteristic, generate at least one display element having the analytic data corresponding to the at least one object characteristic at one or more time intervals, and cause the at least one display element to be displayed in an interface, wherein the interface is configured to size the at least one data element within the user interface to enable the display of a plurality of display elements in the display, the interface being further configured to receive an input corresponding to a user input.

In some embodiments, the program code instructions are further configured to, when executed by the apparatus, cause the performance of an operation associated with the display element that has been selected. The analytic data may include analytic data determined from object data corresponding to a tag location. In some embodiments, the tag is configured to communicate using ultra-wide band signals.

The interface may be configured to display at least one display element configured to display analytic data in varying levels of detail. In some embodiments, the interface is configured to display the at least one display element configured to display analytic data in at least one of an icon form, a graph form, a panel form, and a full function display element form. The full function display element form may be displayed as a larger display element than the icon form, the graph form, and the panel form. In some embodiments, the panel form is displayed as a larger display element than the graph form and the icon form. The graph form may be displayed as a larger display element than the icon form. According to some embodiments, the interface is further configured receive an input corresponding to a user input requesting at least one display element to be change from any one of the display forms to another display form.

Some embodiments of the present invention provide a method comprising receiving location data corresponding to one or more objects in a relation to a field of play at a first time, receiving location data corresponding to the one or more objects in relation to the field of play at a second time, and generating a visualization corresponding to the one or more object to include at least a reference line indicative of a distance traveled by at least one object between the first time and the second time, wherein the first time and the second time occur during a defined event. The location data may include location data determined from object data corresponding to a tag location. According to some embodiments, the tag is configured to communicate using ultra-wide band signals.

According to some embodiments, a method is provided comprising receiving an indication corresponding to a selection of at least one object, receiving an indication corresponding to a selection of at least one criteria of interest, generating a visualization corresponding to the selection of the at least one object using the at least one criteria of interest and object data corresponding to the at least one object, tracking the at least one object and the at least one criteria of interest over a defined time period, and modifying the visualization corresponding to the at least one object to include changes corresponding to the at least one object and the at least one criteria of interest over the defined time period.

In some embodiments, tracking the at least one object over a defined time period comprises tracking at least one tag corresponding to the at least one object. The tag may be configured to communicate using ultra-wide band signals.

According to some embodiments, the visualization corresponding to the selection of the at least one object using the at least one criteria of interest is displayed on an interface, wherein the interface is configured to size the visualization within the user interface, the interface being further configured to receive an input corresponding to a user input. The interface may be configured to display the visualization in varying levels of detail.

Some embodiments of the present invention provide a method comprising receiving an indication corresponding to review one or more visualizations comprising analytics generated based on object data corresponding to one or more objects, receiving an indication corresponding to a selection of a level of detail to display the one or more visualizations, and causing the one or more visualizations to be arranged on an interface such that the visualizations cover a screen area.

In some embodiments, the object data corresponds to at least one tag location. The tag may be configured to communicate using ultra-wide band signals. The interface may be configured to display one or more visualizations comprising analytics in at least one of an icon form, a graph form, a panel form, and a full function display element form based at least in part on the selection of a level of detail to display the one or more visualizations. In some embodiments, the full function display element form displays a greater level of detail than the icon form, the graph form, and the panel form. The panel form may display a greater level of detail than the icon form and the graph form. In some embodiments, the graph form displays a greater level of detail than the icon form.

Another embodiment of the present invention provides a method comprising receiving an indication to review one or more visualizations comprising analytics generated based on object data corresponding to one or more objects, causing the one or more visualizations to be displayed on an interface, receiving an indication corresponding to a configuration selection of the one or more visualizations on the interface, and causing the one or more visualizations to be arranged on an interface corresponding to the indication corresponding to the configuration selection.

The object data may correspond to at least one tag location. In some embodiments, the tag is configured to communicate using ultra-wide band signals. According to some embodiments, the one or more visualizations displayed on the interface comprise analytics in varying levels of detail. The interface is configured to display the one or more visualizations in at least one of an icon form, a graph form, a panel form, and a full function display form. In some embodiments, the full function display form comprises analytics in a greater level of detail than the panel form, the graph form, and the icon form. The panel form may comprise analytics in a greater level of detail than the graph form and the icon form. The graph form may comprise analytics in a greater level of detail than the icon form.

### BRIEF DESCRIPTION OF THE SEVERAL VIEWS OF THE DRAWINGS

Having thus described example embodiments of the present disclosure in general terms, reference will now be made to the accompanying drawings, which are not necessarily drawn to scale, and wherein:

FIG. 1A illustrates a schematic representation of a radio frequency locating system useful for determining the location of an object according to an example embodiment of the present invention;

FIG. 1B illustrates a schematic representation of a system configured to display analytics data according to an example embodiment of the present invention;

FIG. 2 illustrates a block diagram of a computing device configured to provide an interface configured for displaying analytic data according to an example embodiment of the present invention;

FIG. 3 illustrates a flow chart detailing operations performed by a system configured to generate object data according to an example embodiment of the present invention;

FIG. 4 illustrates a flow chart detailing operations performed by a system configured to provide analytic data according to an example embodiment of the present invention;

FIG. 5 illustrates a flow chart detailing operations performed by a system configured to generate visualizations corresponding to an object according to an example embodiment of the present invention;

FIG. 6 illustrates a flow chart detailing operations performed by a system configured to generate visualizations corresponding to an object according to an example embodiment of the present invention;

FIG. 7 illustrates an interface configured to display analytic data provided by a system according to an example embodiment of the present invention;

FIG. 8 illustrates a flow chart detailing operations performed by a system configured to modify visualizations corresponding to an object according to an example embodiment of the present invention;

FIG. 9 illustrates an interface configured to display analytic data provided by a system according to an example embodiment of the present invention;

FIG. 10 illustrates an interface configured to display events and configured to receive an indication corresponding to a selection of an event so as to display analytic data provided by a system that corresponds to the event according to an example embodiment of the present invention;

FIG. 11 illustrates an interface configured to display analytic data provided by a system according to an example embodiment of the present invention;

FIG. 12 illustrates an interface configured to display analytic data provided by a system according to an example embodiment of the present invention;

FIG. 13 illustrates a flow chart detailing operations performed by a system configured to configure the display of visualizations according to one example embodiment of the present invention;

FIG. 14 illustrates various display elements configured to display analytic data provided by a system according to an example embodiments;

FIG. 15 illustrates an interface configured to display analytic data provided by a system according to an example embodiment; and

FIG. 16 illustrates a schematic representation of example object tracking over time in the form of a visualization in accordance with some embodiments of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout.

As used herein, the terms “data,” “content,” “information” and similar terms may be used interchangeably to refer to data capable of being transmitted, received and/or stored in accordance with embodiments of the present invention. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (for example, implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As indicated above, some embodiments of the present invention may be employed in methods, apparatuses, systems and computer program products configured to advantageously provide for displaying analytic data corresponding to an object (e.g., a football player, an individual, a machine or the like), characteristics of an object (e.g., the football player's weight, height, strength, etc.), associations of the object (e.g., the football player's team, opponents, conference, division, past teams, etc.), one or more statistical outcomes for the object (e.g., likelihood football player rushes for more than 100 yards, etc.) and/or the like via an interface. For example, embodiments of the present invention may advantageously provide for displaying analytic data of an object, such as a football player, via an interface such that a desired amount of analytic data is displayed via the interface. In one embodiment, a system may advantageously provide for determining analytic data corresponding to an object and causing analytic data corresponding to the object to be displayed via an interface.

For example, embodiments of the present invention may advantageously provide for displaying analytic data corresponding to a football player's current performance in a present game. In some embodiments, a system may be configured to generate visualizations corresponding to a football player's location at a first time in a game and the football player's location at a second time in the same game so as to illustrate, for example, a football player's movements during a play. In another embodiment, a system may be configured to generate visualizations corresponding to an object and at least one or more criteria of interest (e.g., historical data corresponding to an object, object characteristics, contextual data, climate data, opponent characteristics, statistical data, and/or any suitable metric for analyzing an object). For example, the system may be configured to provide an interface configured to display at least one visualization corresponding to a football player and at least one criteria of interest, such as an object characteristic. In addition, the system may be configured to provide an interface configured to modify the at least one visualization corresponding to the football player and the at least one criteria of interest over a defined time period. For example, the interface may be configured to display a metric related to a football player's conditioning from the first game of a season to the last game of the season.

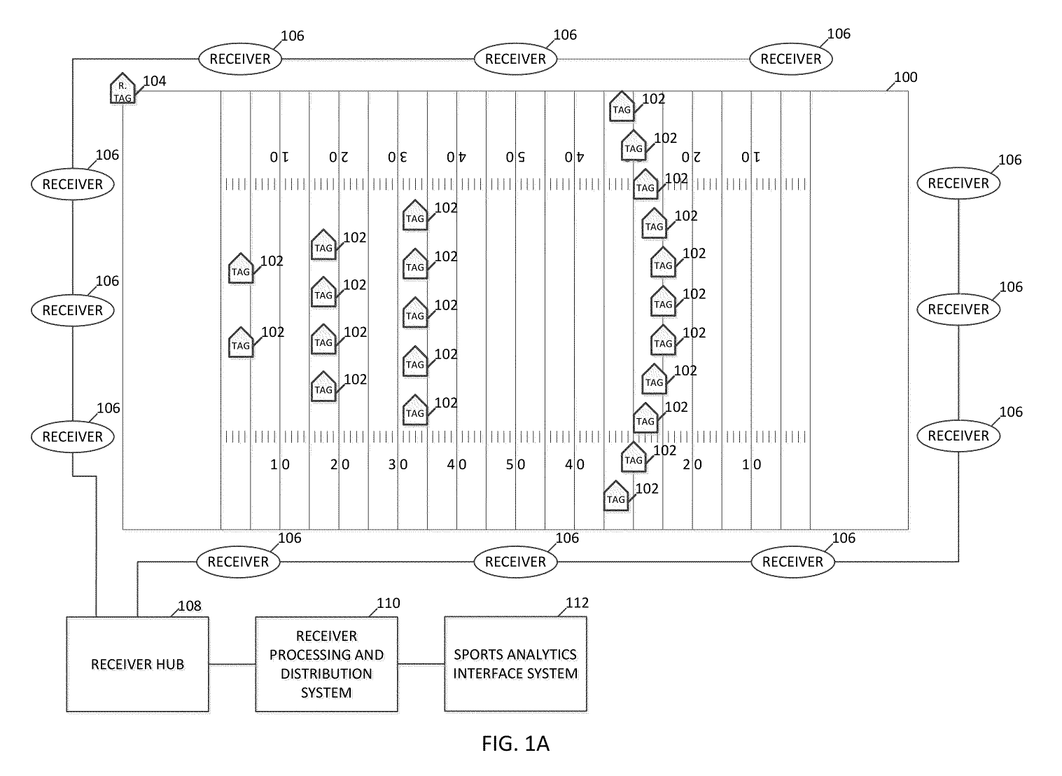

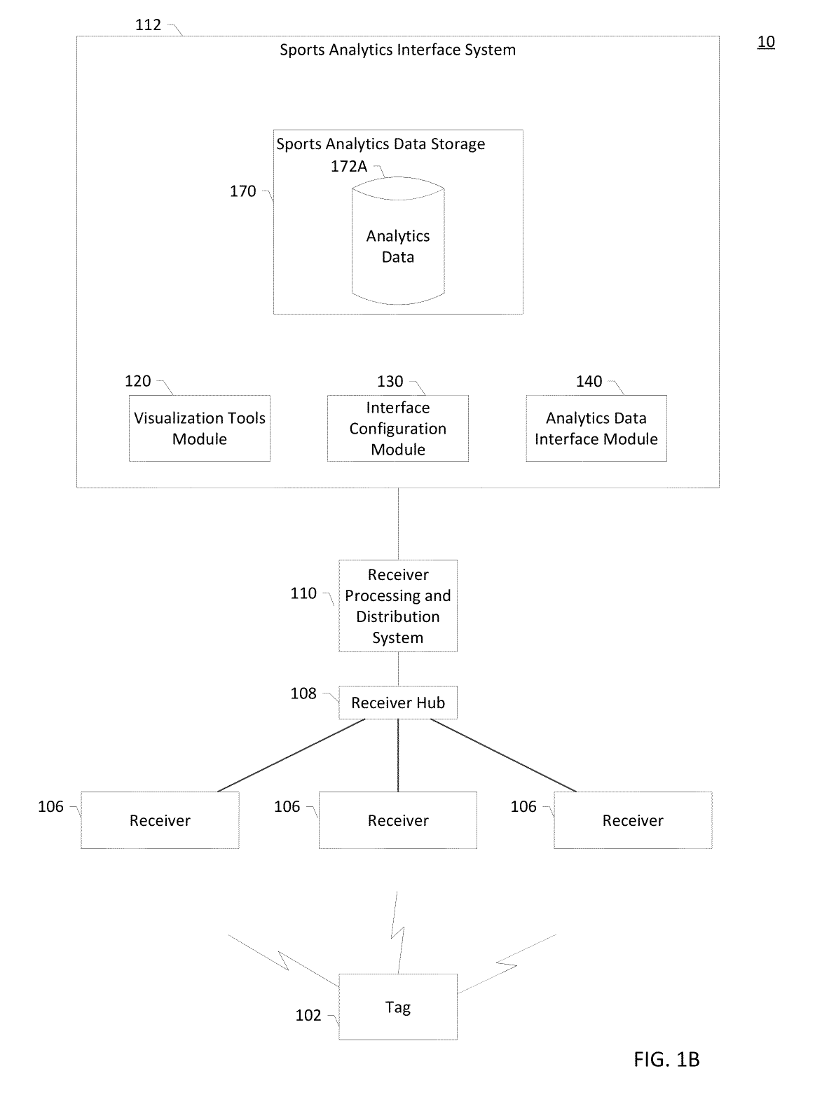

FIG. 1A

illustrates an exemplary locating system 100 useful for calculating a location by an accumulation of location data or time of arrivals (TOAs) at a receiver hub 108, whereby the TOAs represent a relative time of flight (TOF) from RTLS tags 102 as recorded at each receiver 106 (e.g., UWB reader, etc.). A timing reference clock is used, in some examples, such that at least a subset of the receivers 106 may be synchronized in frequency, whereby the relative TOA data associated with each of the RTLS tags 102 may be registered by a counter associated with at least a subset of the receivers 106. In some examples, a reference tag 104, preferably a UWB transmitter, positioned at known coordinates, is used to determine a phase offset between the counters associated with at least a subset of the of the receivers 106. The RTLS tags 102 and the reference tags 104 reside in an active RTLS field. The systems described herein may be referred to as either “multilateration” or “geolocation” systems, terms that refer to the process of locating a signal source by solving an error minimization function of a location estimate determined by the difference in time of arrival (DTOA) between TOA signals received at multiple receivers 106.

In some examples, the system comprising at least the tags 102 and the receivers 106 is configured to provide two dimensional and/or three dimensional precision localization (e.g., subfoot resolutions), even in the presence of multipath interference, due in part to the use of short nanosecond duration pulses whose TOF can be accurately determined using detection circuitry, such as in the receivers 106, which can trigger on the leading edge of a received waveform. In some examples, this short pulse characteristic allows necessary data to be conveyed by the system at a higher peak power, but lower average power levels, than a wireless system configured for high data rate communications, yet still operate within local regulatory requirements.

In some examples, to provide a preferred performance level while complying with the overlap of regulatory restrictions (e.g. FCC and ETSI regulations), the tags 102 may operate with an instantaneous −3 dB bandwidth of approximately 400 MHz and an average transmission below 187 pulses in a 1 msec interval, provided that the packet rate is sufficiently low. In such examples, the predicted maximum range of the system, operating with a center frequency of 6.55 GHz, is roughly 200 meters in instances in which a 12 dBi directional antenna is used at the receiver, but the projected range will depend, in other examples, upon receiver antenna gain. Alternatively or additionally, the range of the system allows for one or more tags 102 to be detected with one or more receivers positioned throughout a football stadium used in a professional football context. Such a configuration advantageously satisfies constraints applied by regulatory bodies related to peak and average power densities (e.g., effective isotropic radiated power density (“EIRP”)), while still optimizing system performance related to range and interference. In further examples, tag transmissions with a −3 dB bandwidth of approximately 400 MHz yields, in some examples, an instantaneous pulse width of roughly 2 nanoseconds that enables a location resolution to better than 30 centimeters.

Referring again to FIG. 1, the object to be located has an attached tag 102, preferably a tag having a UWB transmitter, that transmits a burst (e.g., multiple pulses at a 1 Mb/s burst rate, such as 112 bits of On-Off keying (OOK) at a rate of 1 Mb/s), and optionally, a burst comprising an information packet utilizing OOK that may include, but is not limited to, ID information, a sequential burst count or other desired information for object or personnel identification, inventory control, etc. In some examples, the sequential burst count (e.g., a packet sequence number) from each tag 102 may be advantageously provided in order to permit, at a Receiver hub 108, correlation of TOA measurement data from various receivers 106.

In some examples, the tag 102 may employ UWB waveforms (e.g., low data rate waveforms) to achieve extremely fine resolution because of their extremely short pulse (i.e., sub-nanosecond to nanosecond, such as a 2 nsec (1 nsec up and 1 nsec down)) durations. As such, the information packet may be of a short length (e.g. 112 bits of OOK at a rate of 1 Mb/sec, in some example embodiments), that advantageously enables a higher packet rate. If each information packet is unique, a higher packet rate results in a higher data rate; if each information packet is transmitted repeatedly, the higher packet rate results in a higher packet repetition rate. In some examples, higher packet repetition rate (e.g., 12 Hz) and/or higher data rates (e.g., 1 Mb/sec, 2 Mb/sec or the like) for each tag may result in larger datasets for filtering to achieve a more accurate location estimate. Alternatively or additionally, in some examples, the shorter length of the information packets, in conjunction with other packet rate, data rates and other system requirements, may also result in a longer battery life (e.g., 7 years battery life at a transmission rate of 1 Hz with a 300 mAh cell, in some present embodiments).

Tag signals may be received at a receiver directly from RTLS tags, or may be received after being reflected en route. Reflected signals travel a longer path from the RTLS tag to the receiver than would a direct signal, and are thus received later than the corresponding direct signal. This delay is known as an echo delay or multipath delay. If reflected signals are sufficiently strong enough to be detected by the receiver, they can corrupt a data transmission through inter-symbol interference. In some examples, the tag 102 may employ UWB waveforms to achieve extremely fine resolution because of their extremely short pulse (e.g., 2 nsec) durations. Furthermore, signals may comprise short information packets (e.g., 112 bits of OOK) at a somewhat high burst data rate (1 Mb/sec, in some example embodiments), that advantageously enable packet durations to be brief (e.g. 112 microsec) while allowing inter-pulse times (e.g., 998 nsec) sufficiently longer than expected echo delays, avoiding data corruption.

Reflected signals can be expected to become weaker as delay increases due to more reflections and the longer distances traveled. Thus, beyond some value of inter-pulse time (e.g., 998 nsec), corresponding to some path length difference (e.g., 299.4 m.), there will be no advantage to further increases in inter-pulse time (and, hence lowering of burst data rate) for any given level of transmit power. In this manner, minimization of packet duration allows the battery life of a tag to be maximized, since its digital circuitry need only be active for a brief time. It will be understood that different environments can have different expected echo delays, so that different burst data rates and, hence, packet durations, may be appropriate in different situations depending on the environment.

Minimization of the packet duration also allows a tag to transmit more packets in a given time period, although in practice, regulatory average EIRP limits may often provide an overriding constraint. However, brief packet duration also reduces the likelihood of packets from multiple tags overlapping in time, causing a data collision. Thus, minimal packet duration allows multiple tags to transmit a higher aggregate number of packets per second, allowing for the largest number of tags to be tracked, or a given number of tags to be tracked at the highest rate.

In one non-limiting example, a data packet length of 112 bits (e.g., OOK encoded), transmitted at a data rate of 1 Mb/sec (1 MHz), may be implemented with a transmit tag repetition rate of 1 transmission per second (1 TX/sec). Such an implementation may accommodate a battery life of up to seven years, wherein the battery itself may be, for example, a compact, 3-volt coin cell of the series no. BR2335 (Rayovac), with a battery charge rating of 300 mAhr. An alternate implementation may be a generic compact, 3-volt coin cell, series no. CR2032, with a battery charge rating of 220 mAhr, whereby the latter generic coin cell, as can be appreciated, may provide for a shorter battery life.

Alternatively or additionally, some applications may require higher transmit tag repetition rates to track a dynamic environment. In some examples, the transmit tag repetition rate may be 12 transmissions per second (12 TX/sec). In such applications, it can be further appreciated that the battery life may be shorter.

The high burst data transmission rate (e.g., 1 MHz), coupled with the short data packet length (e.g., 112 bits) and the relatively low repetition rates (e.g., 1 TX/sec), provide for two distinct advantages in some examples: (1) a greater number of tags may transmit independently from the field of tags with a lower collision probability, and/or (2) each independent tag transmit power may be increased, with proper consideration given to a battery life constraint, such that a total energy for a single data packet is less that a regulated average power for a given time interval (e.g., a 1 msec time interval for an FCC regulated transmission).

Alternatively or additionally, additional sensor or telemetry data may be transmitted from the tag to provide the receivers 106 with information about the environment and/or operating conditions of the tag. For example, the tag may transmit a temperature to the receivers 106. Such information may be valuable, for example, in a system involving perishable goods or other refrigerant requirements. In this example embodiment, the temperature may be transmitted by the tag at a lower repetition rate than that of the rest of the data packet. For example, the temperature may be transmitted from the tag to the receivers at a rate of one time per minute (e.g., 1 TX/min.), or in some examples, once every 720 times the data packet is transmitted, whereby the data packet in this example is transmitted at an example rate of 12 TX/sec.

Alternatively or additionally, the tag 102 may be programmed to intermittently transmit data to the receivers 106 in response to a signal from a magnetic command transmitter (not shown). The magnetic command transmitter may be a portable device, functioning to transmit a 125 kHz signal, in some example embodiments, with a range of approximately 15 feet or less, to one or more of the tags 102. In some examples, the tags 102 may be equipped with at least a receiver tuned to the magnetic command transmitter transmit frequency (e.g., 125 kHz) and functional antenna to facilitate reception and decoding of the signal transmitted by the magnetic command transmitter.

In some examples, one or more other tags, such as a reference tag 104, may be positioned within and/or about a monitored region. In some examples, the reference tag 104 may be configured to transmit a signal that is used to measure the relative phase (e.g., the count of free-running counters) of non-resettable counters within the receivers 106.

One or more (e.g., preferably four or more) receivers 106 are also positioned at predetermined coordinates within and/or around the monitored region. In some examples, the receivers 106 may be connected in a “daisy chain” fashion to advantageously allow for a large number of receivers 106 to be interconnected over a significant monitored region in order to reduce and simplify cabling, provide power, and/or the like. Each of the receivers 106 includes a receiver for receiving transmissions, such as UWB transmissions, and preferably, a packet decoding circuit that extracts a time of arrival (TOA) timing pulse train, transmitter ID, packet number, and/or other information that may have been encoded in the tag transmission signal (e.g., material description, personnel information, etc.) and is configured to sense signals transmitted by the tags 102 and one or more reference tags 104.

Each receiver 106 includes a time measuring circuit that measures times of arrival (TOA) of tag bursts, with respect to its internal counter. The time measuring circuit is phase-locked (e.g., phase differences do not change and therefore respective frequencies are identical) with a common digital reference clock signal distributed via cable connection from a Receiver hub 108 having a central timing reference clock generator. The reference clock signal establishes a common timing reference for the receivers 106. Thus, multiple time measuring circuits of the respective receivers 106 are synchronized in frequency, but not necessarily in phase. While there typically may be a phase offset between any given pair of receivers in the receivers 106, the phase offset is readily determined through use of a reference tag 104. Alternatively or additionally, each receiver may be synchronized wirelessly via virtual synchronization without a dedicated physical timing channel.

In some example embodiments, the receivers 106 are configured to determine various attributes of the received signal. Since measurements are determined at each receiver 106, in a digital format, rather than analog in some examples, signals are transmittable to the Receiver hub 108. Advantageously, because packet data and measurement results can be transferred at high speeds to a receiver memory, the receivers 106 can receive and process tag (and corresponding object) locating signals on a nearly continuous basis. As such, in some examples, the receiver memory allows for a high burst rate of tag events (i.e., information packets) to be captured.

Data cables or wireless transmissions may convey measurement data from the receivers 106 to the Receiver hub 108 (e.g., the data cables may enable a transfer speed of 2 Mbps). In some examples, measurement data is transferred to the Receiver hub at regular polling intervals.

As such, the Receiver hub 108 determines or otherwise computes tag location (i.e., object location) by processing TOA measurements relative to multiple data packets detected by the receivers 106. In some example embodiments, the Receiver hub 108 may be configured to resolve the coordinates of a tag using nonlinear optimization techniques.

In some examples, TOA measurements from multiple receivers 106 are processed by the Receiver hub 108 to determine a location of the transmit tag 102 by a differential time-of-arrival (DTOA) analysis of the multiple TOAs. The DTOA analysis includes a determination of tag transmit time t₀, whereby a time-of-flight (TOF), measured as the time elapsed from the estimated tag transmit time t₀ to the respective TOA, represents graphically the radii of spheres centered at respective receivers 106. The distance between the surfaces of the respective spheres to the estimated location coordinates (x₀, y₀, z₀) of the transmit tag 102 represents the measurement error for each respective TOA, and the minimization of the sum of the squares of the TOA measurement errors from each receiver participating in the DTOA location estimate provides for both the location coordinates (x₀, y₀, z₀) of the transmit tag and of that tag's transmit time t₀.

In some examples, the system described herein may be referred to as an “over-specified” or “over-determined” system. As such, the Receiver hub 108 may calculate one or more valid (i.e., most correct) locations based on a set of measurements and/or one or more incorrect (i.e., less correct) locations. For example, a location may be calculated that is impossible due the laws of physics or may be an outlier when compared to other calculated locations. As such one or more algorithms or heuristics may be applied to minimize such error.

The starting point for the minimization may be obtained by first doing an area search on a coarse grid of x, y and z over an area defined by the user and followed by a localized steepest descent search. The starting location for this algorithm is fixed, in some examples, at the mean position of all active receivers. No initial area search is needed, and optimization proceeds through the use of a Davidon-Fletcher-Powell (DFP) quasi-Newton algorithm in some examples. In other examples, a steepest descent algorithm may be used.

One such algorithm for error minimization, which may be referred to as a time error minimization algorithm, may be described in Equation 1:

$$ɛ = {\sum }_{j = 1}^{N} {[ {[ {( x - {x}_{j} )}^{2} + {( y - {y}_{j} )}^{2} + {( z - {z}_{j} )}^{2} ]}^{\frac{1}{2}} - c ( {t}_{j} - {t}_{0} ) ]}^{2}$$

Where N is the number of receivers, c is the speed of light, (xⱼ, yⱼ, zⱼ) are the coordinates of the j^{th} receiver, tⱼ is the arrival time at the j^{th} receiver, and t₀ is the tag transmit time. The variable t₀ represents the time of transmission. Since t₀ not initially known, the arrival times, tⱼ, as well as t₀, are related to a common time base, which in some examples, is derived from the arrival times. As a result, differences between the various arrival times have significance for determining location as well as t₀.

The optimization algorithm to minimize the error ε in Equation 1 may be the Davidon-Fletcher-Powell (DFP) quasi-Newton algorithm, for example. In some examples, the optimization algorithm to minimize the error ε in Equation 1 may be a steepest descent algorithm. In each case, the algorithms may be seeded with an initial location estimate (x, y, z) that represents the two-dimensional (2D) or three-dimensional (3D) mean of the positions of the receivers 106 that participate in the tag location determination.

In some examples, the RTLS system comprises a receiver grid, whereby each of the receivers 106 in the receiver grid keeps a receiver clock that is synchronized, with an initially unknown phase offset, to the other receiver clocks. The phase offset between any receivers may be determined by use of a reference tag that is positioned at a known coordinate position (x_{T}, y_{T}, z_{T}). The phase offset serves to resolve the constant offset between counters within the various receivers 106, as described below.

In further example embodiments, a number N of receivers 106 {R₁: j=1, . . . , N} are positioned at known coordinates (x_{R}_{ⱼ}, y_{R}_{ⱼ}, z_{R}_{ⱼ}), which are respectively positioned at distances d_{R}_{ⱼ} from a reference tag 104, such as given in Equation 2:

d_{R}_{ⱼ}=\sqrt{(x_{R}_{ⱼ}−x_{T})²+(y_{R}_{ⱼ}−y_{T})²+(z_{R}_{ⱼ}−z_{T})²} (2)

Each receiver Rⱼ utilizes, for example, a synchronous clock signal derived from a common frequency time base, such as a clock generator. Because the receivers are not synchronously reset, an unknown, but constant offset Oⱼ exists for each receiver's internal free running counter. The value of the constant offset Oⱼ is measured in terms of the number of fine resolution count increments (e.g., a number of nanoseconds for a one nanosecond resolution system).

The reference tag is used, in some examples, to calibrate the radio frequency locating system as follows: The reference tag emits a signal burst at an unknown time τ_{R}. Upon receiving the signal burst from the reference tag, a count N_{R}_{ⱼ} as measured at receiver Rⱼ is given in Equation 3 by:

N_{R}_{ⱼ}=βτ_{R}+Oⱼ+βd_{R}_{ⱼ}/c (3)

Where c is the speed of light and β is the number of fine resolution count increments per unit time (e.g., one per nanosecond). Similarly, each object tag Tᵢ of each object to be located transmits a signal at an unknown time τᵢ to produce a count Nᵢ_{ⱼ}, as given in Equation 4:

Nᵢ_{ⱼ}=βτᵢ+Oⱼ+βdᵢ_{ⱼ}/c (4)

at receiver Rⱼ where dᵢ_{ⱼ} is the distance between the object tag Tᵢ and the receiver 106 Rⱼ. Note that τᵢ is unknown, but has the same constant value for all receivers. Based on the equalities expressed above for receivers Rⱼ and Rₖ and given the reference tag 104 information, phase offsets expressed as differential count values are determined as given in Equations 5a-b:

$$\begin{matrix}{N}_{{R}_{j}} - {N}_{{R}_{k}} = ( {O}_{j} - {O}_{k} ) + β ( \frac{{d}_{{R}_{j}}}{c} - \frac{{d}_{{R}_{k}}}{c} ) \\ Or , & ( 5 a ) \\ ( {O}_{j} - {O}_{k} ) = ( {N}_{{R}_{j}} - {N}_{{R}_{k}} ) - β ( \frac{{d}_{{R}_{j}}}{c} - \frac{{d}_{{R}_{k}}}{c} ) = {Δ}_{{j}_{k}} & ( 5 b )\end{matrix}$$

Where Δⱼₖ is constant as long as d_{R}_{ⱼ}-d_{Rk} remains constant, (which means the receivers and reference tag are fixed and there is no multipath situation) and β is the same for each receiver. Note that Δⱼ_{ₖ} is a known quantity, since N_{R}_{ⱼ}, N_{R}_{ₖ}, β, d_{R}_{ⱼ}/c, and d_{R}_{ₖ}/c are known. That is, the phase offsets between receivers Rⱼ and Rₖ may be readily determined based on the reference tag 104 transmissions. Thus, again from the above equations, for a tag 102 (Tᵢ) transmission arriving at receivers Rⱼ and Rₖ, one may deduce the following Equations 6a-b:

$$\begin{matrix}{N}_{{i}_{j}} - {N}_{{i}_{k}} = ( {O}_{j} - {O}_{k} ) + β ( \frac{{d}_{{i}_{j}}}{c} - \frac{{d}_{{i}_{k}}}{c } ) = {Δ}_{{j}_{k}} + β ( \frac{{d}_{{i}_{j}}}{c} - \frac{{d}_{{i}_{k}}}{c } ) \\ Or , & ( 6 a ) \\ {d}_{{i}_{j}} - {d}_{{i}_{k}} = ( c \text{/} β ) [ {N}_{{i}_{j}} - {N}_{{i}_{k}} - {Δ}_{{j}_{k}} ] & ( 6 b )\end{matrix}$$

Each arrival time, tⱼ, can be referenced to a particular receiver (receiver “1”) as given in Equation 7:

$${t}_{j} = \frac{1}{β} ( {N}_{j} - {Δ}_{j 1} ) \qquad ( 7 )$$

The minimization, described in Equation 1, may then be performed over variables (x, y, z, t₀) to reach a solution (x′, y′, z′, t₀′).

In some example embodiments, the location of a tag 102 may then be output to the receiver processing and distribution system 110 for further processing of the location data to advantageously provide visualizations, predictive analytics and/or the like.

In some embodiments, the receiver processing distribution system 110 may be configured to communicate with a sport analytics interface system 112, which may be configured to advantageously provide for the effective visualization of analytic data, such as sport analytics data, as described herein. In another embodiment, the receiver processing distribution system 110 may include a sport analytics interface system therein. In some embodiments, a sports analytics interface system 112 may include an electronic device, such as a laptop computer, tablet computer, smartphone, smart television, electronic book reader, touch surface, and/or the like configured to display an interface providing sport analytics data corresponding to a particular object, such as a football player.

As shown in FIG. 1B, in some embodiments, a system 10 may be useful for determining analytic data corresponding to the object and/or causing analytic data corresponding to the object, such as object data related to the location of the object, to be displayed via an interface. In this regard, a sports analytics interface system 112 may be configured to communicate with a receiver processing and distribution system 110, as shown in FIGS. 1A and 1B. Example receiver processing and distribution systems 110 are disclosed in commonly owned U.S. patent application Ser. No. 13/942,316, which was filed Jul. 15, 2013 and is entitled METHOD, APPARATUS, AND COMPUTER PROGRAM PRODUCT FOR PERFORMANCE ANALYTICS DETERMINING PLAY MODELS AND OUTPUTTING EVENTS BASED ON REAL-TIME DATA FOR PROXIMITY AND MOVEMENT OF OBJECTS (“the '316 application”). Further example receiver processing and distribution systems 110 are disclosed in commonly owned U.S. patent application Ser. No. 13/942,139, which was filed Jul. 15, 2013 and is entitled METHOD, APPARATUS, AND COMPUTER PROGRAM PRODUCT FOR MONITORING HEALTH, FITNESS, OPERATION OR PERFORMANCE OF INDIVIDUALS (“the '139 application”). The '316 application and the '139 application are hereby incorporated by reference herein in their entireties.

In some embodiments, the receiver processing and distribution system 110 may include the sports analytics interface system 112 therein. The system 10 may include example communication architecture, which may include one or more devices and sub-systems that are configured to implement some embodiments discussed herein. For example, an object may possess a tag 102, such as an ultra-wide band tag, a near-field communication tag, or the like configured to communicate with at least one receiver 106. The tag 102 may be configured to communicate with the at least one receiver 106 on an ultra-wide band frequency. Although FIG. 1B illustrates a single tag, one of ordinary skill in the art may appreciate in light of this disclosure that an object may possess any number of tags.

While not shown, an object may possess one or more sensors such as accelerometers, magnetometers, time-of-flight sensors, health monitoring sensors (e.g., blood pressure sensors, heart monitors, respiration sensors, moisture sensors, temperature sensors), light sensors, or the like. The sensors may be configured to communicate with receivers 106 directly or indirectly through tags 102 or other transmitters. For example, in one embodiment, a sensor may be connected, wired (e.g., perhaps through wires sewn into a jersey or bodysuit undergarment of a football player) or wirelessly, to tags 102 to provide sensor data to tags 102, which is then transmitted to the receivers 106. In another embodiment, a plurality of sensors (not shown) may be connected to a dedicated antenna or transmitter, perhaps positioned in the helmet of a football player, which may transmit sensor data to one or more receivers.

The term “object data” as used herein refers to data derived from one or more tags, e.g., tag data, tag unique ID, tag-individual correlator, tag-sensor correlator, tag data packets, blink data, time measurements (e.g. time of arrival, time difference of arrival, phase), signal measurements (e.g., signal strength, signal direction, signal polarization, signal phase) and tag location data (e.g., including tag location estimates), and data derived from one or more sensors, e.g., sensor unique ID, stored sensor data, sensor-individual correlator, environmental measurements, and sensor information packets. Object data may further include profile data concerning the object, e.g., biographical data, biometric data, name, identity data, uniform number, team, tag and/or sensor position on the object, and the like.

The system 10 may be configured to generate a visualization corresponding to analytics and/or analytic data of any number of objects possessing any number of tags and/or sensors. The at least one receiver(s) 106 may be configured to communicate with a receiver hub 108, which is configured to output at least location data for a particular object to a receiver processing and distribution system 110. In some embodiments, the receiver hub 108 may be configured to output at least location data for a particular object to a sports analytics interface system 112.

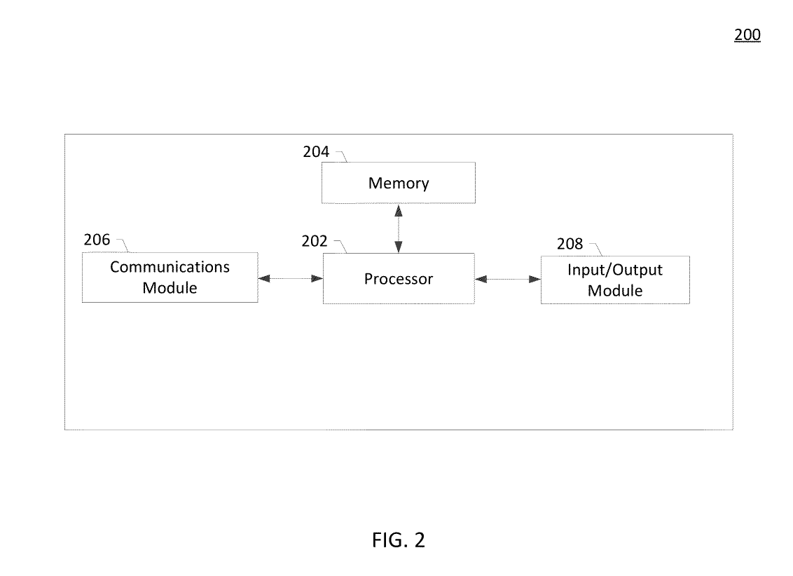

The sports analytics interface system 112 and/or a receiver processing and distribution system 110 may include, for example, circuitry 200, as shown in FIG. 2. In addition, the sports analytics interface system 112 may include a sports analytics data storage 170 (e.g., a data storage layer to capture and store analyzed game data that may include granular and dynamic location information of one or more players), at least one analytics database 172A, a visualization tools module 120, an interface configuration module 130, and/or an analytics data interface module 140.

In some example embodiments, the visualization tools module 120 comprises a set of visualization tools and/or a framework to add additional data visualization tools configured for operation in both a desktop and mobile device. The visualization tool module 120 may further be configured to implement configurable dashboards that enable one or more dashboard components to be viewed, multiple distinct levels of details (e.g., icon— 1/64 of view area, graph— 1/16 of view area, panel—¼ of view area, full function—whole of view area and/or the like), drill down functionality, configurability and, in some examples, a predictable and/or guided software implementation. In some examples, the display and layout that is enabled by the visualization tool module 120 is supportable by one or more dashboard components, visible or hidden, that enable a user to configure, such as by using the interface configuration module 130, a dashboard to display selected components at differing levels of detail without requiring the user to be concerned with layout adjustments.

In some examples, dashboards or display elements may have links or may respond to click events by enabling or otherwise providing navigation, layout control or resizing functionality. In some examples, full screen views and or drill down views may be achieved. In yet further examples, dragging and/or dropping and resizing of the dashboards may be accomplished via the visualization tool module 120. Alternatively or additionally, the dashboard may take the form of one or more defined sizes as referenced above.

The sports analytics interface system 112 may include any suitable network server and/or processing devices, such as a computer, tablet computer, smartphone and/or the like. The at least one analytics data database 172A can be any suitable network database configured to store analytics data. For example, an analytics data database may be configured to store analytics data, such as analytics corresponding to an object such as a football player. Analytics may comprise analytics relating to an object's performance, an object's status, and/or any object characteristic. For example, analytics may comprise statistics related to the object, such as a football player's total yards, total catches, number of touchdowns, and/or the like.

In some examples, the sports analytics interface system 112 may be scalable. For example, the sports analytics interface system 112 may scale in one or more (in some cases 3 or more) directions that include, but are not limited to, quantity of player location data captured and stored, quantity and variety of real time data analysis and/or quantity of users that can visualize and/or track analytics data in real time.

In some embodiments, a sports analytics interface system, such as the sports analytics interface system 112 illustrated in FIGS. 1A and 1B, may be implemented by example circuitry 200, as shown in FIG. 2. For example, circuitry 200 may be included in an electronic device, such as a laptop computer, tablet computer, smartphone, smart television, electronic book reader, touch surface, and/or the like, and may be used to implement a sports analytics interface system. According to some embodiments, circuitry 200 may include at least a processor 202, a memory 204, a communications module 206, and an input/output module 208.

In some embodiments, such as when circuitry 200 is included in a sports analytics interface system 112, one or more modules may be included. As referred to herein, “module” includes hardware, software and/or firmware configured to perform one or more particular functions. In this regard, the means of circuitry 200 as described herein may be embodied as, for example, circuitry, hardware elements (e.g., a suitably programmed processor, combinational logic circuit, and/or the like), a computer program product comprising computer-readable program instructions stored on a non-transitory computer-readable medium (e.g., memory 204) that is executable by a suitably configured processing device (e.g., processor 202), or some combination thereof.

Processor 202 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an application specific integrated circuit (ASIC) or field programmable gate array (FPGA), or some combination thereof. Accordingly, although illustrated in FIG. 2 as a single processor, in some embodiments, processor 202 comprises a plurality of processors. The plurality of processors may be embodied on a single computing device or may be distributed across a plurality of computing devices collectively configured to function as circuitry 200. The plurality of processors may be in operative communication with each other and may be collectively configured to perform one or more functionalities of circuitry 200 as described herein. In an example embodiment, processor 202 is configured to execute instructions stored in memory 204 or otherwise accessible to processor 202. These instructions, when executed by processor 202, may cause circuitry 200 to perform one or more of the functionalities of circuitry 200 as described herein.

Whether configured by hardware, firmware/software methods, or by a combination thereof, processor 202 may comprise an entity capable of performing operations according to embodiments of the present invention while configured accordingly. Thus, for example, when processor 202 is embodied as an ASIC, FPGA or the like, processor 202 may comprise specifically configured hardware for conducting one or more operations described herein. As another example, when processor 202 is embodied as an executor of instructions, such as may be stored in memory 204, the instructions may specifically configure processor 202 to perform one or more algorithms and operations described herein.

Memory 204 may comprise, for example, volatile memory, non-volatile memory, or some combination thereof. Although illustrated in FIG. 2 as a single memory, memory 204 may comprise a plurality of memory components. The plurality of memory components may be embodied on a single computing device or distributed across a plurality of computing devices. In various embodiments, memory 204 may comprise, for example, a hard disk, random access memory, cache memory, flash memory, a compact disc read only memory (CD-ROM), digital versatile disc read only memory (DVD-ROM), an optical disc, circuitry configured to store information, or some combination thereof. Memory 204 may be configured to store information, data, applications, instructions, or the like for enabling circuitry 200 to carry out various functions in accordance with example embodiments discussed herein. For example, in at least some embodiments, memory 204 is configured to buffer input data for processing by processor 202. Additionally or alternatively, in at least some embodiments, memory 204 may be configured to store program instructions for execution by processor 202. Memory 204 may store information in the form of static and/or dynamic information. This stored information may be stored and/or used by circuitry 200 during the course of performing its functionalities.

Communications module 206 may be embodied as any device or means embodied in circuitry, hardware, a computer program product comprising computer readable program instructions stored on a computer readable medium (e.g., memory 204) and executed by a processing device (e.g., processor 202), or a combination thereof that is configured to receive and/or transmit data from/to another device, such as, for example, a second circuitry 200 and/or the like. In some embodiments, communications module 206 (like other components discussed herein) can be at least partially embodied as or otherwise controlled by processor 202. In this regard, communications module 206 may be in communication with processor 202, such as via a bus. Communications module 206 may include, for example, an antenna, a transmitter, a receiver, a transceiver, network interface card and/or supporting hardware and/or firmware/software for enabling communications with another computing device. Communications module 206 may be configured to receive and/or transmit any data that may be stored by memory 204 using any protocol that may be used for communications between computing devices. Communications module 206 may additionally or alternatively be in communication with the memory 204, input/output module 208 and/or any other component of circuitry 200, such as via a bus.

Input/output module 208 may be in communication with processor 202 to receive an indication of a user input and/or to provide an audible, visual, mechanical, or other output to a user. Some example visual outputs that may be provided to a user by circuitry 200 are discussed in connection with the displays described above. As such, input/output module 208 may include support, for example, for a keyboard, a mouse, a joystick, a display, an image capturing device, a touch screen display, a microphone, a speaker, a RFID reader, barcode reader, biometric scanner, and/or other input/output mechanisms. In embodiments wherein circuitry 200 is embodied as a server or database, aspects of input/output module 208 may be reduced as compared to embodiments where circuitry 200 is implemented as an end-user machine (e.g., a mobile device) or other type of device designed for complex user interactions. In some embodiments (like other components discussed herein), input/output module 208 may even be eliminated from circuitry 200. Input/output module 208 may be in communication with memory 204, communications module 206, and/or any other component(s), such as via a bus. Although more than one input/output module and/or other component can be included in circuitry 200, only one is shown in FIG. 2 to avoid overcomplicating the drawing (like the other components discussed herein).

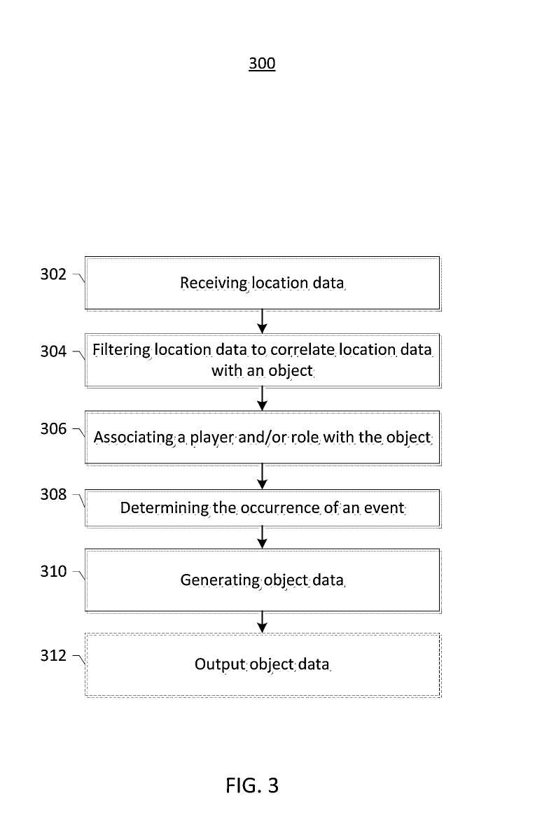

FIG. 3 illustrates a flowchart of an exemplary process for determining and/or predicting analytics using a radio frequency locating system that are to be displayed by an exemplary system, such as a sports analytics interface system 112, in accordance with some embodiments of the present invention. An exemplary method, such as process 300, may be executed by one or more devices (some of which are discussed in connection with FIGS. 1A and 1B). The process may start at 302, where tag location data is received for the tags 102. Additionally, in some embodiments, other sensor data, such as data from accelerometers, proximity sensors, gyroscopes, heart rate monitors and the like, may be received with the tag location data. The tags 102 and (sensors) may be attached to objects, such as players, officials, balls, field markers, penalty flags, other game equipment, and reference markers on a field of play (e.g., boundary defining reference markers). In some embodiments, each object may be associated with one or more tags 102 (e.g., multiple tags 102 may be attached to an individual football player's equipment, such as to provide more accurate location and multi-dimensional location or orientation data).

At 304, a filter, such as a filter in the receiver processing and distribution system 110 may process the tag location data to identify tags 102 that are associated with a given object (e.g., multiple tags attached to a player, a ball, an official, etc.). The filter may correlate the tag location data associated with multiple tags 102 where the multiple tags 102 are associated with the same object (e.g., player or official), such as to provide more accurate data regarding the activities of the object.

At 306, the receiver processing and distribution system 110 may compare the tag identifier (e.g., a tag ID) to a database of player roles to determine the associated player (e.g., a player profile) and role. In some example embodiments, the receiver processing and distribution system may use the tag location data, the player role data for each individual player, and player dynamics/kinetics models to determine player dynamics (e.g., multi-dimensional player position information) for each player, such as location, change in location, orientation, velocity, acceleration, deceleration, or the like.

At 308, the receiver processing and distribution system may determine the likelihood that an event has occurred (e.g., particular play has formed, a play has started, a play is in progress, or a play has ended). In some embodiments, the receiver processing and distribution system may also receive an indication of the actions of game officials to further improve play determination accuracy. In some embodiments, the receiver processing and distribution system may also receive a data stream from a ball, a sideline, and/or the like to assist in generating play data.

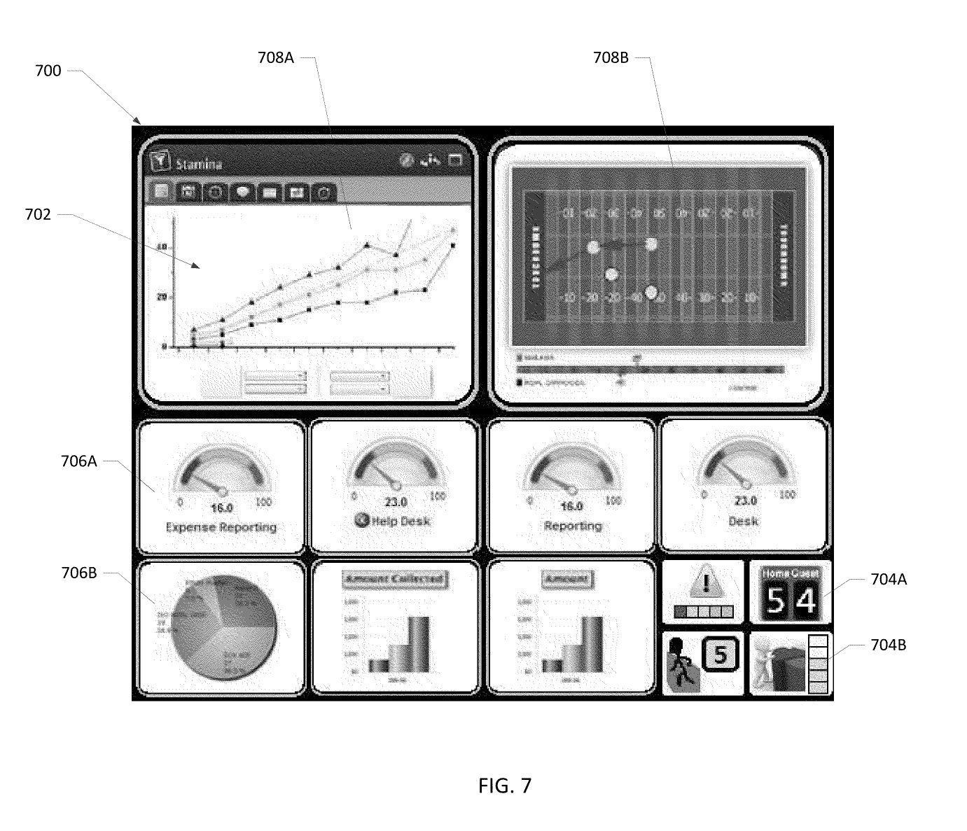

At 310, the receiver processing and distribution system may generate a stream of events, statistics, analytics and/or the like for the game, the players, and the teams which may be output as object data to perform additional analytics, operations, or the like. According to some embodiments, the receiver processing and distribution system may be configured to output object data to a sports analytics interface system configured to provide an interface for displaying events, statistics, analytics, and/or the like corresponding to a game, players, and/or teams, such as via the visualizations shown in FIGS. 7 and 9 through 12.

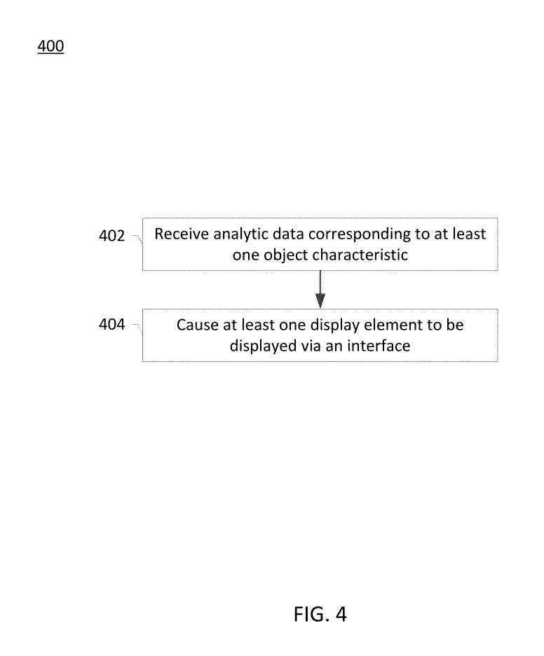

Accordingly, a sports analytics interface system 112 may receive such object data corresponding to a stream of events, statistics, analytics and/or the like for a game, players, and/or teams and may be further configured to generate a visualization of such object data. In this regard, FIG. 4 illustrates an exemplary method, such as process 400, that may be executed by one or more devices (some examples of which are discussed in connection with FIGS. 1A, 1B, and 2) to provide a display, such as a touch screen display 700 of FIG. 7, with an interface configured to display analytic data that is derived based on location data, object data and/or the like. In some embodiments, analytic data may correspond to an object, such as a football player, a group of objects or the like. According to other embodiments, analytic data may correspond with an association, such as a football team. As is described herein, analytic data is data (e.g. statistical data) that is derived from the object data. In some examples, analytic data for an object may include distance traveled, yards traveled with the football, speed or the like. Analytic data may also include object data for a plurality of objects, such as, total distance traveled for all objects, total yards by an offense, average speed of all objects or the like. Analytic data may also be derived based on a data model, a predictive model, a learning model or the like. For example, the location data may be suggestive of a objects injury level, stamina or the like.

At 402, a sports analytics interface system may receive analytic data corresponding to at least one object characteristic. For example, a sports analytics interface system 112, as shown in FIGS. 1A and 1B, may receive analytic data corresponding to a location of an object over a period of time. In some embodiments, the sports analytics interface system may be configured to receive analytic data corresponding to an object characteristic, such as a football player's conditioning, weight, stamina, status, and/or the like.

According to one embodiment, a football player may possess a sensor, such as a tag 102 configured to communicate with a receiver 106 via ultra-wide band signals, as illustrated in FIGS. 1A and 1B. The tag 102 may be configured to transmit data corresponding to the location of the tag in a given instance, as described herein. In some embodiments, a football player may possess a tag 102 on the player's equipment, body, and/or the like. For example, the tag 102 may be disposed within the player's protective gear, such as a football helmet. In some embodiments, the football player may possess other sensors, such as a heart rate monitor, accelerometer, thermometer, and/or the like, that are configured to communicate with the receiver 106, receiver hub 108, receiver processing and distribution system 110, and/or sports analytics interface system 112.

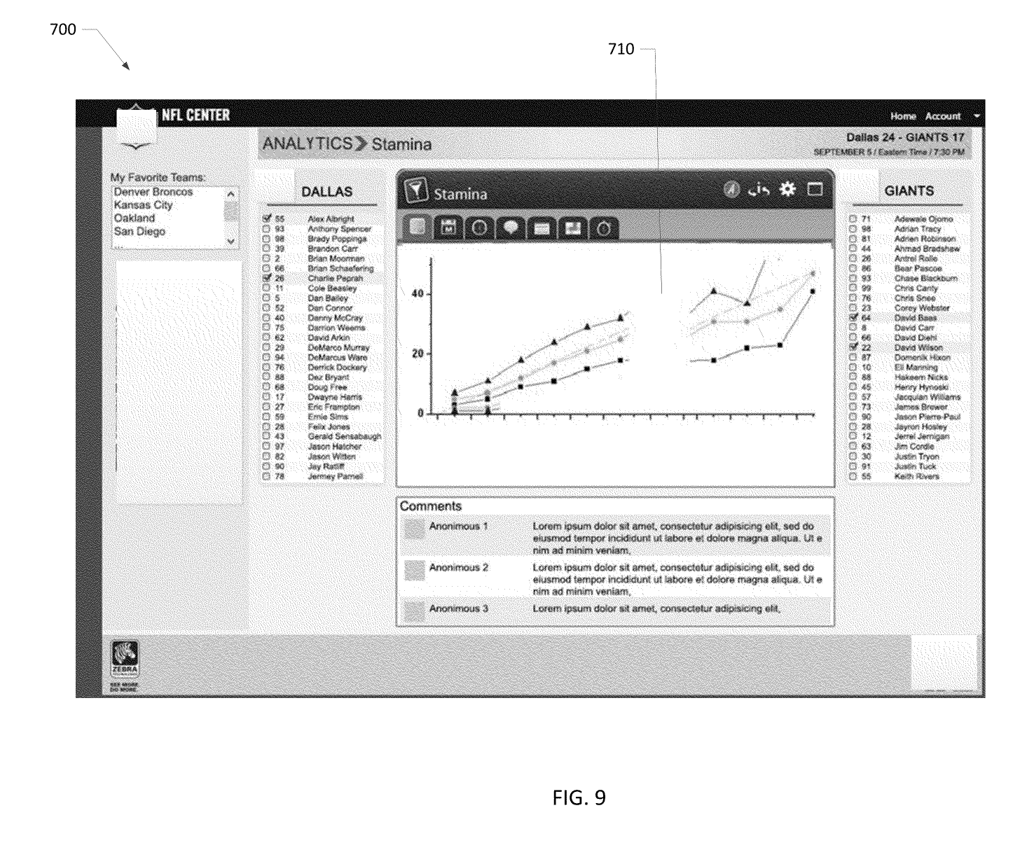

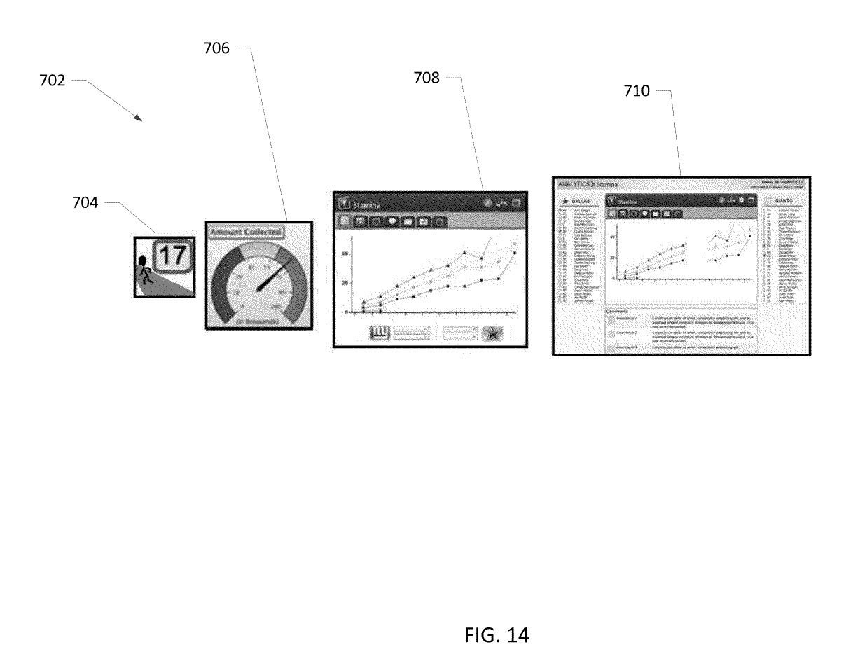

At 404, the sports analytics interface system may be configured to cause at least one display element (i.e., dashboard) to be displayed via an interface. For example, as shown in FIGS. 4 through 8, a display 700, such as a touch screen display, may be configured to display an interface providing visualizations corresponding to analytics date, such as sport analytics data. With respect to FIG. 7, a display 700 may include a plurality of display elements 702. In some embodiments, the display elements 702 may comprise an icon form 704, a graph form 706, a panel form 708 and/or the like. The display elements or dashboards are further described with reference to FIG. 14 and, in some examples, are defined as a function of the screen area that they occupy (e.g., icon— 1/64 of view area, graph— 1/16 of view area, panel—¼ of view area, full function—whole of view area and/or the like). In some embodiments, the plurality of display elements may comprise a full function form 710, as shown in FIG. 9.

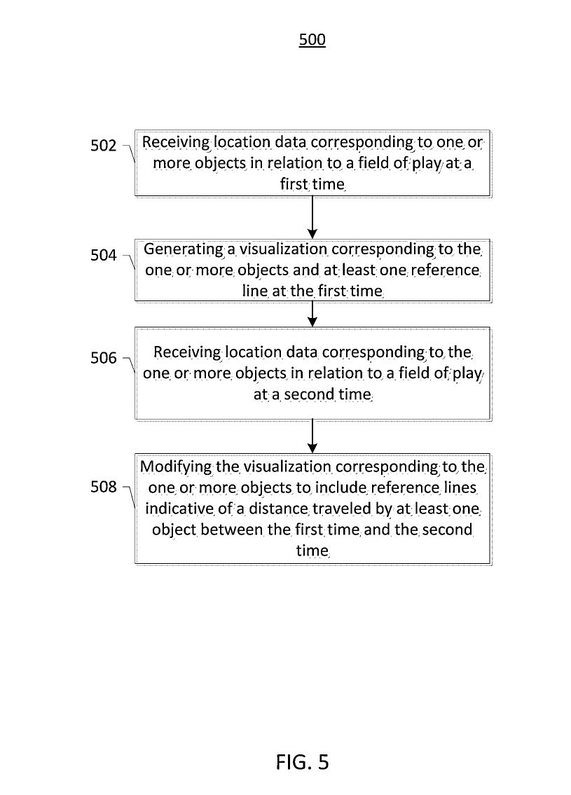

FIG. 5 illustrates a method for providing an interface configured to display visualizations corresponding to sport analytics data. An exemplary method, such as process 500, may be executed by one or more devices (some examples of which are discussed in connection with FIGS. 1A, 1B, and 2). At 502, receiver processing and distribution system 110 and/or a sports analytics interface system 112 may receive object data, such as object data generated with respect to FIG. 3. For example, the receiver processing and distribution system 110 and/or a sports analytics interface system 112 may receive location data corresponding to one or more objects in relation to a field of play. In some embodiments, the receiver processing and distribution system 110 and/or a sports analytics interface system 112 may receive object data, such as location data of a football player at a first time, such as the football player's location at the beginning of the play.

At 504, a sports analytics interface system 112 may be configured to generate a visualization corresponding to the one or more objects and at least one reference line at the first time. For example, the sports analytics interface system 112 may be configured to generate a visualization corresponding to the football player's location and a reference line corresponding to the change in location from a previous play to the football player's location at the first time, such as at the beginning of the present play.

At 506, the receiver processing and distribution system 110 and/or sports analytics interface system 112 may be configured to receive object data corresponding to one or more objects in relation to a field of play at a second time. For example, the receiver processing and distribution system may be configured to receive location data corresponding to the location of a football player in relation to a field of play at a second time.

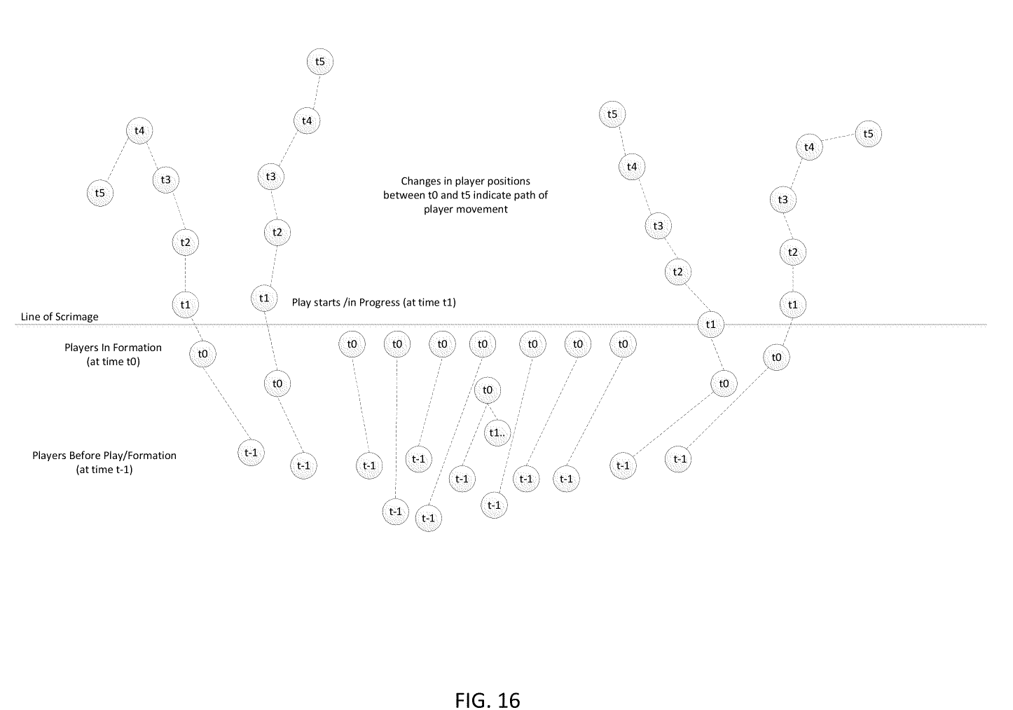

At 508, the sports analytics interface system 112 may be configured to modify a visualization corresponding to the one or more objects to include reference lines indicative of a distance traveled by the at least one object between the first time and the second time. For example, the sports analytics interface system 112 may be configured to provide an interface displaying a modified visualization corresponding to the football player's location at the end of the play that began at the first time corresponding to steps 502 and 504. For example, as shown in FIG. 7, one visualization, such as a panel form 708B, and/or FIG. 16 may correspond to the location data received at a first time and a second time during a process 500. In addition, the sports analytics interface system 112 may be configured to modify the visualization, such as the panel form 708B, such that the visualization displayed corresponds to an object and at least one reference line at a first time, such as a football player's location and a reference line indicative of a distance traveled prior to a first time, while the modified visualization displayed illustrates the football player's location at a second time and a reference line indicative of the distance traveled by the football player between the first time and the second time.

In some examples, the visualization may comprise a line that tracks one or more objects and their respective paths of travel for a set duration of time, such as a play. For example, each offensive and defensive player may be tracked so as to provide a viewer with a real time (or near real time) visualization of the play. In some examples, the ball may be tracked to provide an accurate representation of the current play or activity. As such, this visualization may provide a game like experience to a viewer not able to watch the game live or via some other audio/visual means. Such visualization data may also be stored for purposes of coaching, future analytics and/or the like.

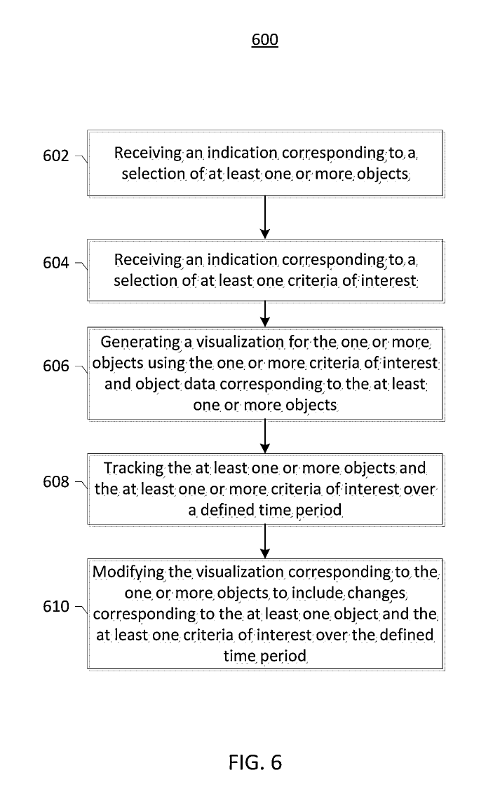

FIG. 6 illustrates a method for generating a visualization corresponding to an object and at least one criteria of interest according to some example embodiments of the present invention. An exemplary method, such as process 600, may be executed by one or more devices (some examples of which are discussed in connection with FIGS. 1A, 1B, and 2). At 602, a sports analytics interface system, such as the sports analytics interface system 112 of FIGS. 1A and 1B may receive an indication corresponding to a selection of at least one or more objects. For example, an indication may correspond to a selection of at least one or more object, such as a user's particular favorite team, a particular player, a particular position, a particular piece of machinery and/or the like.

At 604, a sports analytics interface system may be configured to receive an indication corresponding to a selection of at least one criteria of interest. In some embodiments, the at least one criteria of interest may correspond to the at least one object. In some embodiments, a user may provide an indication corresponding to a selection of an object, such as the user's favorite player. In some examples, a group of objects may be selected, such as a group of objects on a team or within a defined area. In addition, the user may provide an indication corresponding to at least one criteria of interest, such as the number of rushing yards a particular player accrues on average in a particular game. Accordingly, at 606, the sports analytics interface system may be configured to generate a visualization for the one object (i.e., the user's favorite team) using the one or more criteria of interest (i.e., the amount of rushing yards a particular team amasses per game). In addition, the sports analytics interface system may be configured to provide the visualization to an interface via a display element, such as any of the display elements shown in FIG. 7.

At 608, the sports analytics interface system may be configured to track the at least one or more objects and the at least one or more criteria of interest over a defined time period. In some examples, the time period may be defined by a domain specific time range (e.g., last x plays, last y games, games a through b, last z operations, etc.), may defined based on the passage of time (e.g., last x minutes, last y weeks, etc.) may defined based on a time range and/or the like. In other examples, time may be defined as a function of a domain measure. For example, a clock in a football game, a production cycle clock, a shift clock or the like. In such cases, clock data may be captured and compared to the analytic data received. For example, the sports analytics interface system may be configured to track a user's favorite team and the amount of rushing yards the user's favorite team accrues over each of the next 5 games. Accordingly, at 610, the sports analytics interface system may be configured to modify the visualizations corresponding to the one or more objects to include changes corresponding to the at least one object and the at least one criteria of interest over the defined time period. As such, for example, the visualizations may be modified to display the amount of rushing yards the user's favorite team amasses in the next 5 games after the completion of the 5 games. In another embodiment, the visualizations may be modified to display the amount of rushing yards the user's favorite team gains after each of the next 5 games.

In another example embodiment, a user may provide and the sports analytics interface system may receive an indication corresponding to a selection of an object, such as a particular football player at step 602. At 604, the user may provide and the sports analytics interface system may receive an indication corresponding to a selection of at least one criteria of interest, such as a particular player's stamina level.

Accordingly, at step 606, the sports analytics interface system may be configured to generate a visualization corresponding to the particular football player and the football player's stamina level. Stamina is a measure that is defined in part based on distance travel based on location data, but may also include measurements that define a level of force applied, number of calories burned or the like. In some examples, a computational learning model may be trained to learn objects stamina levels over time. While stamina may be derived based on a knowledge of that players stamina compared to a current amount of effort expended, other criteria related to statistics derived from the object data or the like may be displayed. At step 608, the sports analytics interface system may be configured to track the football player and the football player's stamina level over a defined time period, such as throughout a particular game. As such, at step 610, the sports analytics interface system may be configured to modify the visualization such that any changes in the football player's stamina level throughout the defined time period (i.e., the football game) is displayed via an interface configured to display the modified visualization.

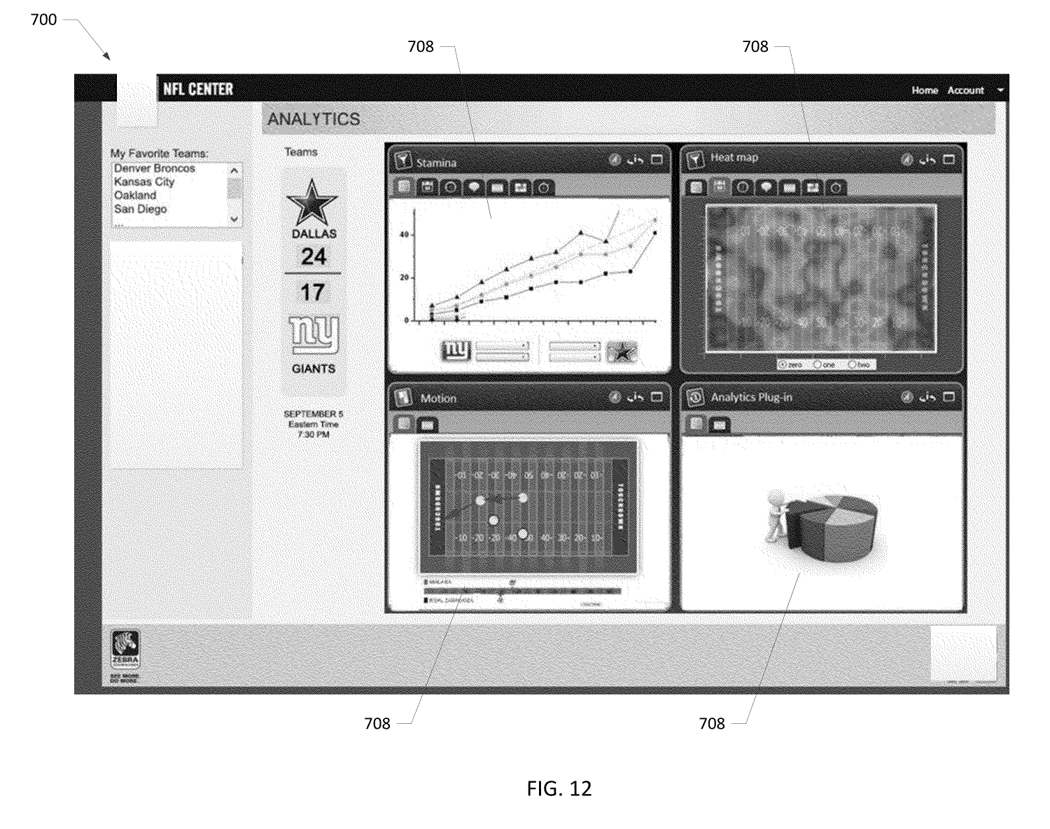

Referring to FIG. 7, FIG. 7 illustrates a display 700 illustrating a plurality of display elements 702 (i.e., dashboards) configured to provide at least one visualization according to an example embodiment. In some embodiments, the visualizations provided by a display element may differ in size with respect to one another. Accordingly, a visualizations tool module may be configured to provide a visualization providing analytic data in accordance with the particular size of a particular display element. In one embodiment, each of the display elements 702 may be proportional sized with respect to one another. For example, a display element such as an icon form 704 may be one-quarter the size of a graph form 706. Likewise, a graph form 706 may be one quarter the size of a panel form 708. According to some embodiments, a panel form 708 may be one-quarter the size of a full function form 710 (e.g. the entire view area). Although FIGS. 7 and 12 illustrate display elements 702 being one-quarter the size of the next larger sized display element, one skilled in the art may appreciate in light of this disclosure that display elements may be sized in any suitable fashion to effectively display analytic data. For example, a display element, such as a graph form, may be optionally sized to be double the size of another display element, such as an icon form.

In addition, each of the display elements 702 may be configured to provide analytic data in an effective fashion that corresponds to the display element size. For example, as shown in FIG. 7, an icon form 704 may be configured to convey basic context data that may be derived from analytic data or may be derived from one or more other sources, such as the score of a game. A larger sized display element, such as a panel form 708 may be configured to convey greater detailed analytic data, such as particular locations of football players during a particular football play in a game. Likewise, a graph form 706 may be configured to convey analytic data in greater detail than a smaller display element, such as an icon form 404, but convey less detailed analytic data than a larger display element, such as a panel form 708 and/or a full function form 710.

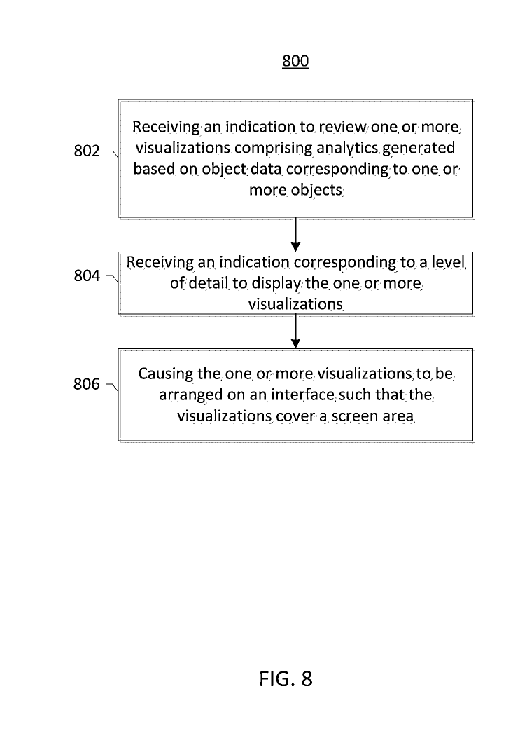

In this regard, FIG. 8 illustrates a method for displaying a visualization on an interface according to some embodiments of the present invention. An exemplary method, such as process 800 may be executed by one or more devices (some examples of which are discussed in connection with FIGS. 1A, 1B, and 2). At 802, a sports analytics interface system, such as the sports analytics interface system 112 of FIGS. 1A and 1B, may be configured to receive an indication corresponding to a user input to review one or more visualizations comprising analytics generated based on object data corresponding to one or more objects. In some embodiments, a display 700 may provide an interface configured to display the one or more visualizations comprising analytics generated based on the object data.

At 804, a sports analytics interface system may be configured to receive an indication corresponding to the level of detail to display in the one or more visualizations provided by the interface. For example, as discussed herein, the display 700 may display an interface comprising a plurality of display elements 702 configured to provide at least one visualization comprising analytics corresponding to an object. In addition, the display elements 702 may vary in size, and in some embodiments, may vary the amount of analytics displayed in accordance with the display element size.

At 806, the sports analytics interface system may be configured to display one or more visualizations on an interface such that the visualizations cover a screen area of a display 700. For example, a user may provide at least one indication, such as via a touch input to a touch screen display, corresponding to the level of detail to display the plurality of visualizations. As shown in FIG. 7, the indication may correspond with displaying an analytic, such as the stamina of a particular football player in a larger display element, such as a panel form 708A, and displaying another analytic, such as the score of a game, time of possession or the like in a smaller display element, such as icon form 704A.

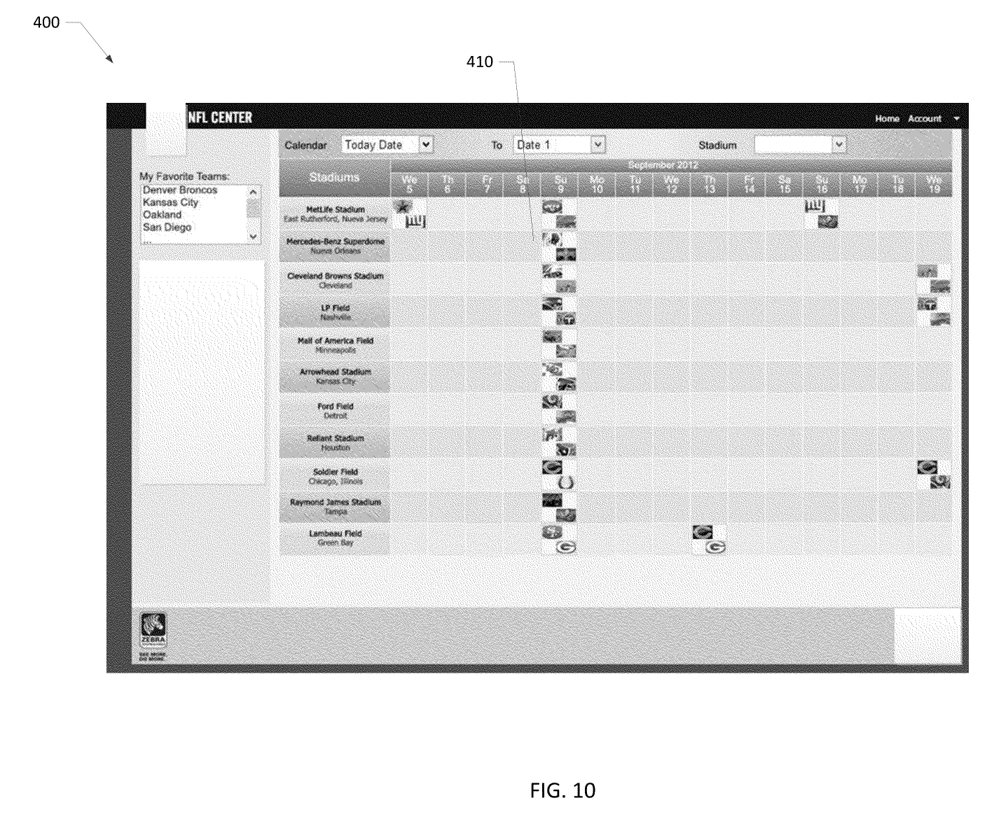

According to another embodiment, larger sized display elements 702, such as a full function form 710 may be configured to provide an interface user with greater interaction, analytic data, and/or the like, as shown in FIG. 9. For example, a display element, such as a full function form 710, may be configured to display a scheduling calendar of past games previously played, games currently in progress, and/or upcoming games to be played. In addition, the full function form 710 displaying a scheduling calendar, as shown in FIG. 10, may be configured to receive a user input, such as a touch input on a touch screen display configured to display the interface. In some embodiments, a user may provide a touch input corresponding to a selection of a particular game. The interface may be configured to receive the touch input corresponding to the selection of a particular game and may be further configured to display analytic data corresponding to the particular game.

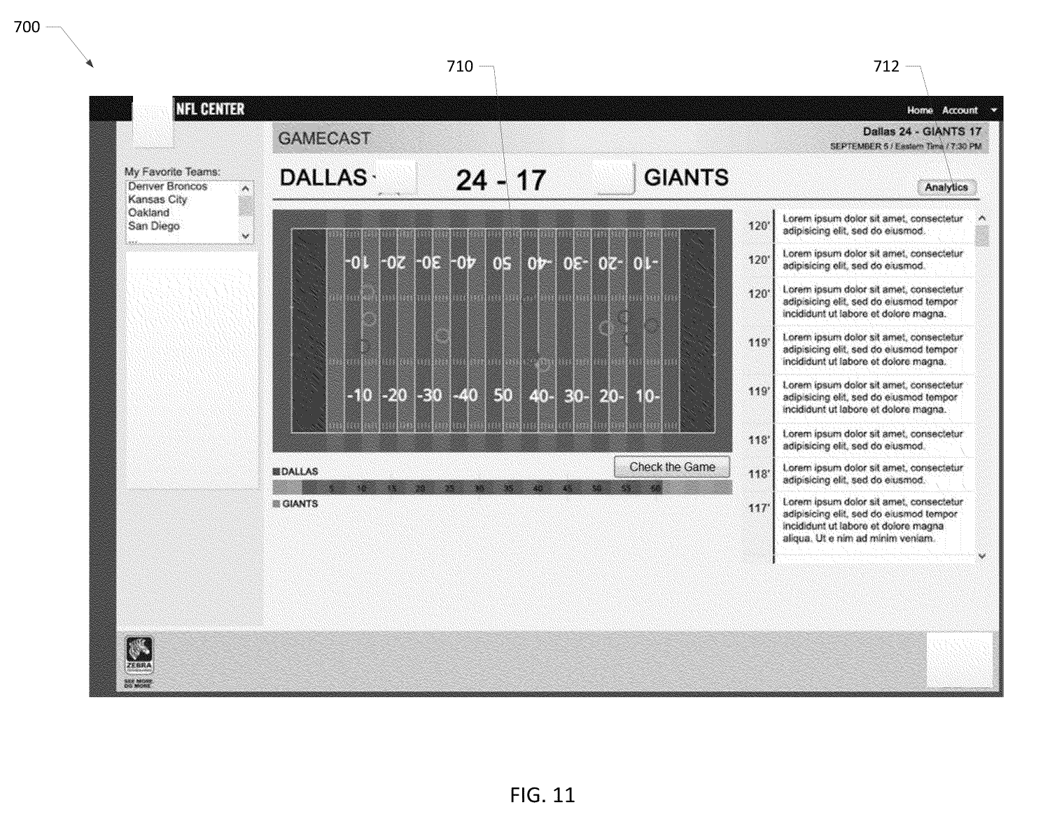

As shown in FIG. 11, a user input selecting a game between two football teams may cause the interface to display a full function form 710 display element configured to provide analytic data corresponding to the selected game. For example, FIG. 11 illustrates a full function form 710 providing analytic data corresponding to a historical record of the particular game selected. In some embodiments, a display element such as any one of the icon form 704, graph form 706, panel form 708, and/or full function form 710 may include additional display elements, such as button 712, as shown in FIG. 11. Selection of button 712 via providing a touch input to the touch display proximate the button 712 may be configured to cause the interface to provide additional analytic data. For example, as is shown in FIG. 11, a user input corresponding to a selection of button 712 may cause the interface to display analytic data corresponding to greater detailed historical analytic data. In some embodiments, a user input corresponding to a selection of another display element, such as button 712, may cause the interface to display a plurality of display elements, such as panel forms 708, as shown in FIG. 12.

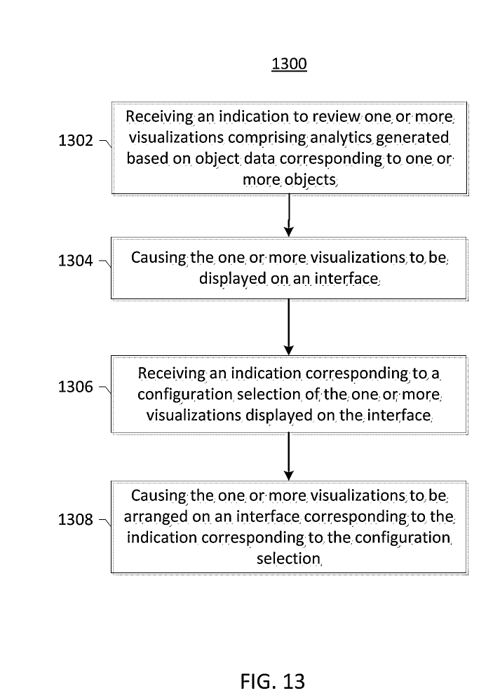

In this regard, FIG. 13 illustrates a method for configuring visualizations corresponding to analytics generated based on object data corresponding to one or more objects. An exemplary method, such as process 1300, may be executed by one or more devices (some examples of which are discussed in connection with FIGS. 1A, 1B, and 2). At 1302, a sports analytics interface system may be configured to receive an indication to review one or more visualizations comprising analytics generated based on object data corresponding to one or more visualizations. For example, a touch screen display 700 may be configured to receive a touch input corresponding to a user's input requesting a plurality of analytics to be displayed on an interface whereas other input methods may be used in other example embodiments.

As such, at 1304, the sports analytics interface system may be configured to display the one or more visualizations on an interface that may be displayed on a touch screen display. For example, a user may wish to view analytics corresponding to a number of objects and a number of criteria of interest. In one embodiment, a user may wish to view analytics for all running backs of a particular time corresponding to the stamina levels, the amount of playing time, the total yards rushed, and the number of touchdowns in the last 5 games. Accordingly, at 1304, the sports analytics interface system may be configured to display a number of display elements on a touch screen display corresponding to each of the running backs and each of the criteria of interest. In some embodiments, the analytics may be displayed in various forms in accordance with the amount of detail the user wishes to view.

For example, the stamina level for each of the running backs may be displayed in a line graph form in a panel form 708 corresponding to stamina level at every minute for the past 5 games. In addition, the interface may be configured to display the number of touchdowns in an icon form displaying the total number of touchdowns for each of the running backs in the last 5 games.

In some examples, stamina, injury status and/or other analytics that may be derived from location data, sensors on an object such as accelerometers, gyroscopes, temperature sensors, calorie monitors or the like and cannot be derived based on statistics alone. For example, stamina cannot be accurately described as a function statistics like yards per carry or yards per reception, but instead may be tracked based on location data and other sensor data captured herein. For example, a receiver may have a single reception of 10 yards in a game, however that same receiver may have run a total of 1000 yards during the game without every catching the ball.

At 1306, the user may provide and the sports analytics interface system may receive an indication corresponding to a configuration selection of the one or more visualizations displayed on the interface. In some embodiments, an interface configuration module, such as the interface configuration module 130, may be configured to cause the one or more visualizations to be arranged and/or modified on an interface corresponding to the indication corresponding to the configuration selection.

For example, at 1306, the user may provide an indication corresponding to a desire to see a particular analytic in greater detail and another analytic in less detail. As such, an interface configuration module may be configured to modify and/or change a visualization in accordance with such an indication. For example, the stamina level of all of the running backs as previously displayed in a line graph form, which was previously provided in a panel form 708 via the interface, may be modified to display the current stamina level of all of the running backs after the last 5 games in a number form. In another embodiment, the sports analytics interface system may be configured to change and/or modify a visualization provided via an icon form, such as the total number of touchdowns in the last 5 games for a particular team's running backs, to a modified visualization provided via a panel form, such as a bar graph presented via the panel form indicating the number of touchdowns a particular running back had in each of the 5 games.

Alternatively or additionally, as a visualization or is resized, the visualization may ingest or otherwise calculate different statistics. For example, a simple estimation of stamina (e.g., a stamina score out of a 100, a red, yellow or green indication or the like) level may be provided in a first visualization. In a second or larger visualization, data may be displayed that correlates to the underlying data used to calculate stamina. Such a display would allow a domain expert, such as a coach, to determine the meaning of the data. In some cases, the domain expert may see an excess of high impact hits that are suggestive of a concussion or a reduction in ability to perform at a high level. In other cases, a level of stationary, high force activity (blocking) may have a greater impact on a wide receiver when compared to a lineman. In alternative embodiment, a computational learning system may be used.

Alternatively or additionally, the visualizations may include a coaches view that may display or otherwise convey raw location data, raw sensor data or the like. In such cases, a domain expert may want to view the underlying data so as to come to their own conclusions. For example, while yards traveled or yards per catch may be indicative of the performance of a player, a coach may want to view actual location tracking of each route run, position of defender with respect to each route run, effort applied to each block or the like. Such visualizations may allow domain experts to analyze and evaluate behavior in more detail.

In another embodiment, the sports analytics interface system may be configured to increase or decrease the number of visualizations displayed on an interface via the plurality of display elements. For example, a plurality of display elements may provide a plurality of visualizations corresponding to a plurality of analytics on the touch screen display. At 1306, the user may provide an indication corresponding to a desire to see a particular analytic in greater detail. Accordingly, the sports analytics interface system may be configured to increase the size of the display element to cover the screen area such that a particular analytic is shown in greater detail. For example, the interface may be configured to display a plurality of display elements, such as plurality of panel forms, one panel form displaying the stamina level for a particular running back during each of the 5 past games. Upon receiving an indication corresponding to a configuration selection of the stamina visualization, the sports analytics interface system may be configured to cause the particular visualization to increase in size such that the particular analytic is shown in greater detail. For example, an indication to display the panel form of the stamina visualization in greater detail may cause the sports analytics interface system to display a stamina visualization in a full function form, such as the full function form 710, that covers the entire screen area. In addition, the full function form of a stamina visualization may provide the stamina level of the running back at each minute for each of the past 5 games.

Accordingly, the sports analytics interface system may provide, not only a larger display size, but additional detail not previously provided in a previous visualization. Such additional detail is shown, for example, with respect to Figure to FIG. 14. FIG. 14 illustrates various display elements 702 that may be configured to display various analytics in accordance with the size of the display element. As previously mentioned, the display elements 702 may comprise an icon form 704, a graph form 706, a panel form 708, a full function form 710 and/or the like. According to some embodiments, the sports analytics interface system may provide analytics corresponding to a particular object and a criteria of interest (e.g., a particular running back and the running back's stamina level). In some embodiments, the sports analytics interface system may provide varying levels of analytic detail based at least in part on the size of the display element. As such, generalized analytics corresponding to a particular object and a criteria of interest may be displayed when the display element 702 comprises an icon form 704, while detailed analytics corresponding to the same particular object and the same criteria of interest may be displayed when the display element comprises a larger sized display element, such as a panel form 708. According to some embodiments, the level of detail may increase in accordance with an increase in size of the display element. As such, a full function form 710 may display greater detailed analytics (e.g., a graph that includes a roster and a series of descriptive comments or social media) than a panel form 708 (e.g., the graph alone), which may display greater detail than a graph form 706 (e.g., an indication of a current value in a dial and not the value over time as tracked in the graph), which may display greater detail than an icon form 704 (e.g., a number alone).

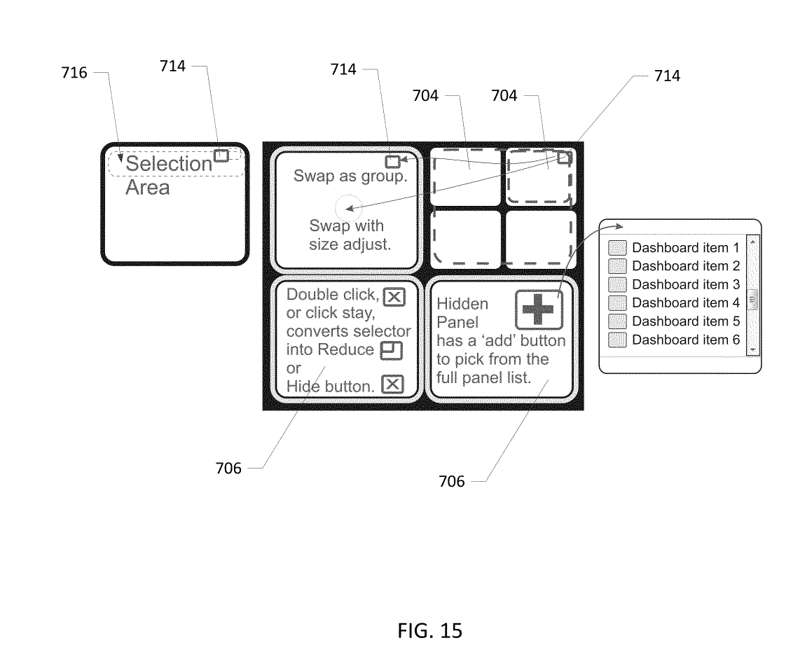

FIG. 15 illustrates an interface configured to display analytics provided by a system in accordance with some embodiments of the present invention. More specifically, FIG. 15 illustrates various inputs that may be provided to an interface so as to configure the display elements displayed by the interface. For example, a user may select a group of icon forms 704 by providing an input 714, such as a touch input, disposed proximate an upper corner of a group of icon forms. A user may swap the position of a group of icon forms 704 with a graph form 706 by providing an input corresponding to a selection of the group of icon forms and dragging the group of icon forms to a location proximate an upper corner of the graph form 706 the user wishes to swap positions. In some embodiments, the interface may be configured to swap not only the positions of a particular group of display elements with another display element, but may also be configured to change the size of a particular display element being relocated. For example, a user may decide to select a particular icon form 704 to swap positions with a particular graph form 706. In addition, the user may wish to resize the selected icon form 704 to a graph form 706 so as to view additional analytics corresponding to the analytics currently being displayed in the icon form 704. As such, the user may select the particular icon form 704 by providing a touch input 714 disposed proximate an upper corner of the particular icon form 704 and dragging the particular icon form 704 to the center of graph form 706. As such, the graph form 706 may be resized and repositioned as an icon form in the now vacated position of the particular icon form 704 that has been resized as a graph form 706.

According to some embodiments, the interface may be configured to receive additional inputs corresponding to additional actions for configuring the display of particular display elements. In some embodiments, an input corresponding to a double tap of a selection area 716 may cause the interface to hide and/or close a particular display element. In another embodiment, an input 714 corresponding to an extended tap of a selection area may cause the particular display element to reduce in size. In some embodiments, providing an input 714 corresponding to a tap of a selection area of a hidden display element (e.g., an empty display element, a blank display element, and/or the like) may cause the interface to display a list of display elements that may be displayed by the interface. Accordingly, a user may provide an input 714 corresponding to a tap of a selection area of a hidden display element to add additional display elements displaying additional analytics currently displayed (i.e., a larger sized display element displaying analytics corresponding to a smaller sized display element currently being displayed). In some embodiments, a user may provide an input 714 corresponding to a tap of a selection area of a hidden display element to add additional display elements displaying analytics not currently displayed (i.e., a display element displaying analytics corresponding to a new object and/or a new criteria of interest).

FIG. 16 illustrates example object (e.g., player) tracking over time in the form of a visualization in accordance with some embodiments of the present invention. More specifically, FIG. 16 illustrates the changing position of an offensive team during game action in a fashion that could be provided via one or more visualizations described herein. Such tracking of changing positions may be useful for visualization in order to provide an in game experience (e.g., a game tracker application). For example, at a first time, t−1, the tag located data indicates that the tracked players are positioned well behind the line of scrimmage and therefore not set for a particular player. At a second time, t0, certain of the tracked players (e.g., offensive linemen and receivers) have positioned themselves proximate the line of scrimmage, thus, suggesting a high probability of a pro set offensive formation and the start of a play. At a third time, t1, certain tracked players (e.g., the receivers and the quarterback) move away from the line of scrimmage, thus, suggesting that a play has begun. Additional times t2 through t5 may be similarly tracked as shown. The tag location data recorded at times t−1 through t5 provide for a data stream indicating the motions/paths of the various players throughout the duration of a play. It is noted that FIG. 16 does not illustrate tracking of all the players after t0 in order to simplify the illustration.

Any such computer program instructions and/or other type of code may be loaded onto a computer, processor or other programmable apparatuses circuitry to produce a machine, such that the computer, processor or other programmable circuitry that executes the code may be the means for implementing various functions, including those described herein.

The illustrations described herein are intended to provide a general understanding of the structure of various embodiments. The illustrations are not intended to serve as a complete description of all of the elements and features of apparatus, processors, and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

The above disclosed subject matter is to be considered illustrative, and not restrictive, and the appended claims are intended to cover all such modifications, enhancements, and other embodiments, which fall within the true spirit and scope of the description. Thus, to the maximum extent allowed by law, the scope is to be determined by the broadest permissible interpretation of the following claims and their equivalents, and shall not be restricted or limited by the foregoing detailed description.

1. A method comprising:
receiving analytic data corresponding to at least one object characteristic, wherein the analytic data includes analytic data determined from object data corresponding to a tag location;
generating at least one display element having the analytic data corresponding to the at least one object characteristic at one or more time intervals; and
causing the at least one display element to be displayed in an interface, wherein the interface is configured to size the at least one data element within the user interface to enable the display of a plurality of display elements in the display, the interface being further configured to display location data for an object in at least one display element and receive an input corresponding to a user input.

2. The method of claim 1 further comprising causing, via a processor, based at least in part on the input, the performance of an operation associated with the display element that has been selected.

3. The method of claim 1, wherein the analytic data includes data derived from a tag location over a defined time period.

4. The method of claim 3, wherein the tag is configured to communicate using ultra-wide band signals.

5. The method of claim 1, wherein the interface is configured to display at least one display element configured to display analytic data in varying levels of detail.

6. The method of claim 5, wherein the interface is configured to display the at least one display element configured to display analytic data in at least one of an icon form, a graph form, a panel form, and a full function display element form.

7. The method of claim 6, wherein the full function display element form is displayed as a larger display element than the icon form, the graph form, and the panel form.

8. The method of claim 7, wherein the panel form is displayed as a larger display element than the graph form and the icon form.

9. The method of claim 8, wherein the graph form is displayed as a larger display element than the icon form.

10. The method of claim 6, wherein the interface is further configured receive an input corresponding to a user input requesting at least one display element to be change from any one of the display forms to another display form.

11. An apparatus comprising at least one processor and at least one memory including computer program code, the at least one memory and the computer program code configured to, with the processor, cause the apparatus to:
receive analytic data corresponding to at least one object characteristic wherein the analytic data includes analytic data determined from object data corresponding to a tag location;
generate at least one display element having the analytic data corresponding to the at least one object characteristic at one or more time intervals; and
cause the at least one display element to be displayed in an interface, wherein the interface is configured to size the at least one data element within the user interface to enable the display of a plurality of display elements in the display, the interface being further configured to display location data for an object in at least one display element and receive an input corresponding to a user input.

12. The apparatus of claim 11 wherein the at least one memory and the computer program code configured to, with the processor, further cause the apparatus to perform an operation associated with the display element that has been selected.

13. The apparatus of claim 11, wherein the analytic data includes data derived from a tag location over a defined time period.

14. The apparatus of claim 13, wherein the tag is configured to communicate using ultra-wide band signals.

15. The apparatus of claim 11, wherein the interface is configured to display at least one display element configured to display analytic data in varying levels of detail.

16. The apparatus of claim 15, wherein the interface is configured to display the at least one display element configured to display analytic data in at least one of an icon form, a graph form, a panel form, and a full function display element form.

17. The apparatus of claim 16, wherein the full function display element form is displayed as a larger display element than the icon form, the graph form, and the panel form.

18. The apparatus of claim 17, wherein the panel form is displayed as a larger display element than the graph form and the icon form.

19. The apparatus of claim 18, wherein the graph form is displayed as a larger display element than the icon form.

20. The apparatus of claim 16, wherein the interface is further configured receive an input corresponding to a user input requesting at least one display element to be change from any one of the display forms to another display form.

21. A computer program product comprising:
at least one computer readable non-transitory memory medium having program code instructions stored thereon, the program code instructions which when executed by an apparatus cause the apparatus at least to:
receive analytic data corresponding to at least one object characteristic wherein the analytic data includes analytic data determined from object data corresponding to a tag location;
generate at least one display element having the analytic data corresponding to the at least one object characteristic at one or more time intervals; and
cause the at least one display element to be displayed in an interface, wherein the interface is configured to size the at least one data element within the user interface to enable the display of a plurality of display elements in the display, the interface being further configured to display location data for an object in at least one display element and receive an input corresponding to a user input.

22. The computer program product according to claim 21, wherein the program code instructions are further configured to, when executed by the apparatus, cause the performance of an operation associated with the display element that has been selected.

23. The computer program product according to claim 21, wherein the analytic data includes data derived from a tag location over a defined time period.

24. The computer program product according to claim 23, wherein the tag is configured to communicate using ultra-wide band signals.

25. The computer program product according to claim 21, wherein the interface is configured to display at least one display element configured to display analytic data in varying levels of detail.

26. The computer program product according to claim 25, wherein the interface is configured to display the at least one display element configured to display analytic data in at least one of an icon form, a graph form, a panel form, and a full function display element form.

27. The computer program product according to claim 26, wherein the full function display element form is displayed as a larger display element than the icon form, the graph form, and the panel form.

28. The computer program product according to claim 27, wherein the panel form is displayed as a larger display element than the graph form and the icon form.

29. The computer program product according to claim 28, wherein the graph form is displayed as a larger display element than the icon form.

30. The computer program product according to claim 26, wherein the interface is further configured receive an input corresponding to a user input requesting at least one display element to be change from any one of the display forms to another display form.

31-53. (canceled)
